(19) United States
(12) Patent Application Publication
(10) Pub. No.: US 2016/0180296 A1
(43) Pub. Date: Jun. 23, 2016

(54) CONTROLLING A USER INTERFACE IN A COMPUTER DEVICE

(71) Applicant: Cognis Software Limited, East Sussex (GB)

(72) Inventor: Jim McDonald, East Sussex (GB)

(21) Appl. No.: 14/581,665

(22) Filed: Dec. 23, 2014

(30) Foreign Application Priority Data
Dec. 22, 2014 (GB) GB1422990.0

(51) Int. Cl. G06Q 10/10; G06F 3/0484

(52) U.S. Cl. CPC G06Q 10/1095; G06F 3/0484

(57) ABSTRACT

The invention relates to computer system for controlling a user interface, the system comprising: a processor executing a calendar application as a computer program; electronic storage connected to the processor for holding user data, activity data, and activity status; a user input component configured to receive from a first user activity data defining an activity to be scheduled in a calendar, and a constraint associated with the activity; a constraint input configured to receive constraint data; wherein the calendar application is configured to process the constraint data to determine if the constraint has been met, and to set the activity status based on whether the constraint has been met and to generate control instructions for controlling a user interface to selectively present the activity to a user based on the activity status.

### TECHNICAL FIELD

The invention relates to controlling a user interface in a computer device.

### BACKGROUND

The present invention relates to controlling a user interface in a computer device, and in particular to controlling what activities to provide to a user in an electronic calendar.

Many people use electronic calendars of one sort or another, be it on their desktop computer or a mobile device such as a mobile telephone or tablet. Electronic calendars help people to keep track of their appointments as well as allowing others to send them invitations to appointments.

Existing calendars are limited in their ability to control what activities are provided to a user—in fact, if an entry has been made in a calendar, it is displayed to the user who made it and to any invitees who accept an invitation to attend the activity.

As electronic calendars are increasingly utilised, this gives rise to cluttered and complex user interfaces, and user frustration in managing their diary.

### SUMMARY

According to an aspect of the present invention, there is provided a computer system for controlling a user interface, the system comprising: a processor executing a calendar application as a computer program; electronic storage connected to the processor for holding user data, activity data, and activity status; a user input component configured to receive from a first user activity data defining an activity to be scheduled in a calendar, and a constraint associated with the activity; a constraint input configured to receive constraint data; wherein the calendar application is configured to process the constraint data to determine if the constraint has been met, and to set the activity status based on whether the constraint has been met and to generate control instructions for controlling a user interface to selectively present the activity to a user based on the activity status.

Embodiments of the present invention propose a new type of electronic calendar which contains information about the purpose of each activity and constraints for each activity which must be met for the activity to occur. Constraints are also applied for each person directly related to the activity, as well as those indirectly related through being part of a constraint for the same. Resolution of these constraints for each activity results in at most one activity which requires the person's attention for any given time.

Conventional electronic calendars have been unable to differentiate between any given person's requirements for and interests in any single activity. There is also no way to describe either the impact that an activity has on an invitee's time, or how active the invitee needs to be in participation of the activity. The combination of these problems result in people commonly being double- or triple-booked for a given time slot, resulting in confusion and missed meetings for both meeting organisers and invitees.

These problems are fundamentally unsolvable with conventional electronic calendars due to the lack of a semantic layer where such information as that above might reside, and a mechanism which can take advantage of such information to resolve conflicts that arise.

The constraint can be an occurrence constraint which defines at least one factor which governs whether or not the activity will take place. For example, the factor could be attendance of a particular user, or a particular prevailing weather condition.

The constraint can be an attendance constraint, which can be imposed by someone other than the first user and which can define whether or not this other user attends the activity. The attendance constraint can be for example attendance by a further user to the activity.

When attendance constraints are utilised, an activity status can differ between users. The calendar application can generate control instructions for a user interface associated with a particular user and selectively present that activity to the user based on the activity status for that particular user. The activity status is based on whether or not the attendance constraint set by that particular user has been met.

The system can provide a conflict resolution module which selects one of multiple activities requesting to be scheduled in a common timeslot, and operates to selectively present only one of the multiple activities to a user in the timeslot.

In one embodiment, the activity is associated with a timeslot, and a conflict resolution module is provided to select one of the multiple activities requesting to be scheduled in a common timeslot.

In one embodiment the conflict resolution component operates to selectively present only one of the multiple activities to a user in the timeslot.

In one embodiment the electronic storage comprises a calendar data structure in which the first user is associated with multiple activities associated with respective timeslots.

Each activity can be associated with display information for presenting the activity to a user on the user interface.

The user input can be configured to receive activity data in the form of natural text.

The calendar application may be configured to control the user interface to present multiple activities scheduled in a common timeslot to permit the user to select a desired activity for storage in association with that timeslot in the calendar.

A prioritization component can be provided which is configured to receive activity data of multiple activities and to associate priorities with the activities based on the activity data, wherein the calendar application is configured to control the user interface to present the activities in differing manners depending on the associated priorities.

According to another aspect of the invention a computer system for controlling a user interface comprises:
a processor executing a calendar application as a computer program;
electronic storage connected to the processor for holding user data, activity data, and permission data;
a user input component configured to receive from a user activity data defining an activity to be scheduled in a calendar, and privacy data associated with the activity, wherein the privacy data defines viewing permissions for the activity;
wherein the calendar application is configured to receive a request from a user to view a calendar and to present to the user interface only activities associated with privacy data which grant the requesting user permission to view the activity.

According to another aspect of the invention, a user input component for a computer system which comprises a processor executing a calendar application as a computer program is configured to receive from a user activity data defining an activity to be scheduled in a calendar in plain text, wherein a text parsing component parses the text and matches it with information known to the system to define activity data for storing in a calendar data structure.

Another aspect of the invention allows activities to be displayed in a differing manner depending on a weighting assigned to the activity.

According to another aspect of the present invention, there is provided a computer system for controlling a user interface, the system comprising: a processor executing a calendar application as a computer program; electronic storage connected to the processor for holding user data and activity data; an input component configured to receive activity data defining multiple activities to be scheduled in a calendar for a user; a conflict resolution module configured to select one of said multiple activities requesting to be scheduled in a common timeslot, and operate to selectively present only one of the multiple activities to the user in the timeslot.

According to another aspect of the present invention, there is provided a computer system for controlling a user interface, the system comprising: a processor executing a calendar application as a computer program; electronic storage connected to the processor for holding user data and activity data; a user request component configured to receive from a uses a request for activity data defining one or more potential activities for the user; wherein the calendar application is further configured to retrieve and present on a user interface, the one or more potential activities for the user, such that the user is able to select one or more of the potential activities to be scheduled in a calendar for the user.

### BRIEF DESCRIPTION OF THE DRAWINGS

For a better understanding of the present invention and to show how it may be carried into effect, reference will now be made by way of example to the accompanying drawings in which:

FIG. 1 shows an electronic calendar system of the present invention;

FIG. 2 shows an example architecture of an end-user device;

FIGS. 3a and 3b show a representation of an activity from the perspective of a first user and a second user;

FIG. 4 shows a flow process for an occurrence constraint

FIG. 5 shows a flow process for an occurrence OR constraint

FIG. 6 shows a flow process for an occurrence CASC constraint

FIG. 7 shows a flow process for an occurrence weather constraint

FIG. 8 shows a flow process for an occurrence and attendance constraint

FIG. 9a shows a representation of an activity with an occurrence pick-up constraint and an occurrence drop-off constraint

FIG. 9b shows a flow process for an occurrence pick-up constraint

FIG. 10 shows a representation of activities associated with a first user

FIG. 11 shows a flow process for a conflict resolution process

FIG. 12 shows a representation of activities associated with a first user that have been subject to a conflict resolution process

FIGS. 13a and 13b show an example of an electronic calendar with redacted information

FIG. 14 shows a request window for making a request for an activity

FIG. 15 shows a result of the request for an activity

FIG. 16 shows a flow process for making a request for an activity and receiving a result

FIG. 17 shows an example of an electronic calendar as displayed to a user

FIG. 18 shows an example of an electronic calendar as displayed to a user

FIG. 19 shows an example of an electronic calendar as displayed to a user

### DETAILED DESCRIPTION

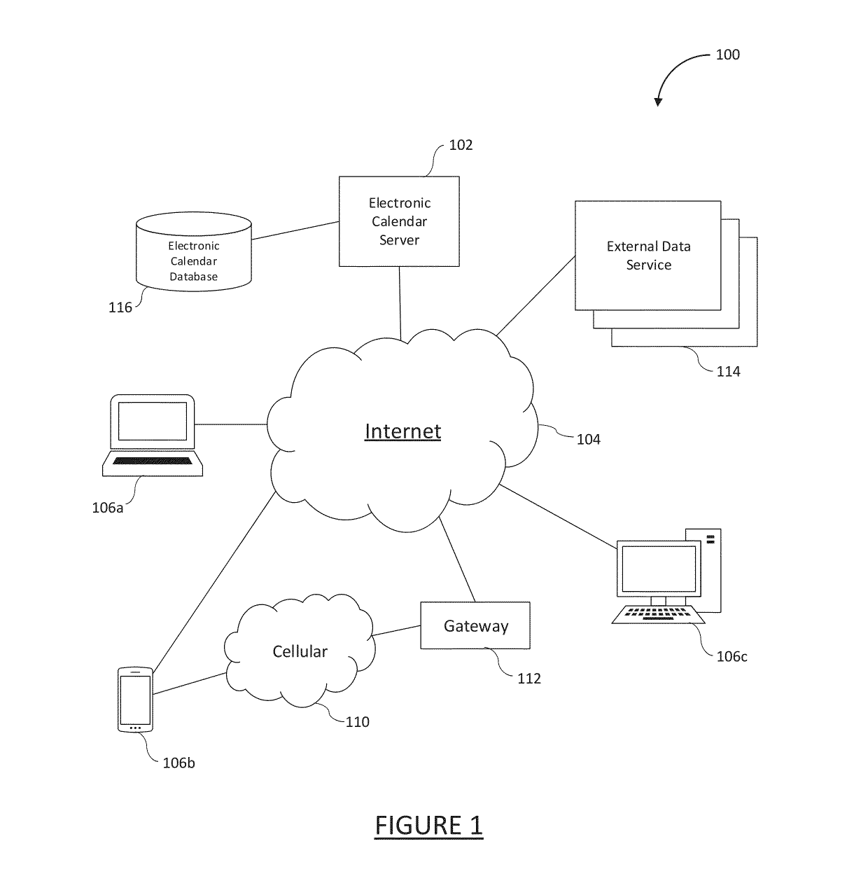

FIG. 1 shows an example illustration of how the electronic calendar system of the present invention is configured. The constraint and conflict resolutions are managed at one or more electronic calendar servers 102 connected to a Wide Area Network such as the Internet 104. The calendar server may also be connected to an electronic calendar database 116 at which data relating current and historical Activities for the users can be stored and retrieved by the electronic calendar server 102. Further connected to the Internet 104 is a plurality of end user devices 106a, 106b and 106c. The end user devices 106 may be any of mobile telephones, laptop PCs, desktop PCs, tablet computers, Personal Digital Assistants, smart televisions, smart watches, or the like, each of which are configured to run an instance of electronic calendar application software 108 compatible with the electronic calendar server 102. The electronic calendar application software 108 may define a full proprietary electronic calendar application that utilises benefits associated with the electronic calendar system in accordance with embodiments described below, when installed and run on the user's end user device 106. Alternatively, the electronic calendar application software 108 can be a plug-in that is installed and run in parallel with one or more existing electronic calendars known to a user and already installed or otherwise accessed by the user on an end user device 106. For example, the known electronic calendar may be an installed program or application e.g. Microsoft Outlook, Apple iCal, or a web-based application e.g. Google Calendar, Yahoo! Calendar. In this latter case, a user can use his existing and familiar electronic calendar(s) while still utilising the benefits associated with the electronic calendar system as described in more detail in the embodiments below.

End user devices 106 are able to connect to the Internet 104 so that they are communicable over the Internet 104 with one another and also communicable with the electronic calendar server 102. The electronic calendar server 102 and end user devices 106 communicate with each other by sending and receiving IP data packets over the Internet 104.

FIG. 1 further shows a plurality of third party external data services 114. Each external data service may be implemented by one or more servers connected to the Internet 104. The external data services 114 are communicable with the end user devices 106 and with the electronic calendar server 102.

Some or all of the end user devices may also be configured to connect to one or more other, non-IP networks, for example a cellular network such as a 3GPP or 4G++ network 110. Any user devices 106 connected to such other non-IP (e.g. cellular) networks may send and receive non-IP data, e.g. cellular data. A skilled person will understand that a gateway 112 can be utilised to allow for end user devices 106 connected via a non-IP network 112 to connect with the Internet 104 and ultimately with the electronic calendar server 102 and external data services 114.

In FIG. 1, the Internet 104 and the one or more other non-IP networks 110 are each represented schematically by communications clouds. However, it will of course be appreciated that many more elements make up these networks. For example the Internet 104 will include many other end user terminals, servers and gateways, as well as routers of Internet service providers (ISPs) and Internet backbone routers not shown in FIG. 1 for conciseness.

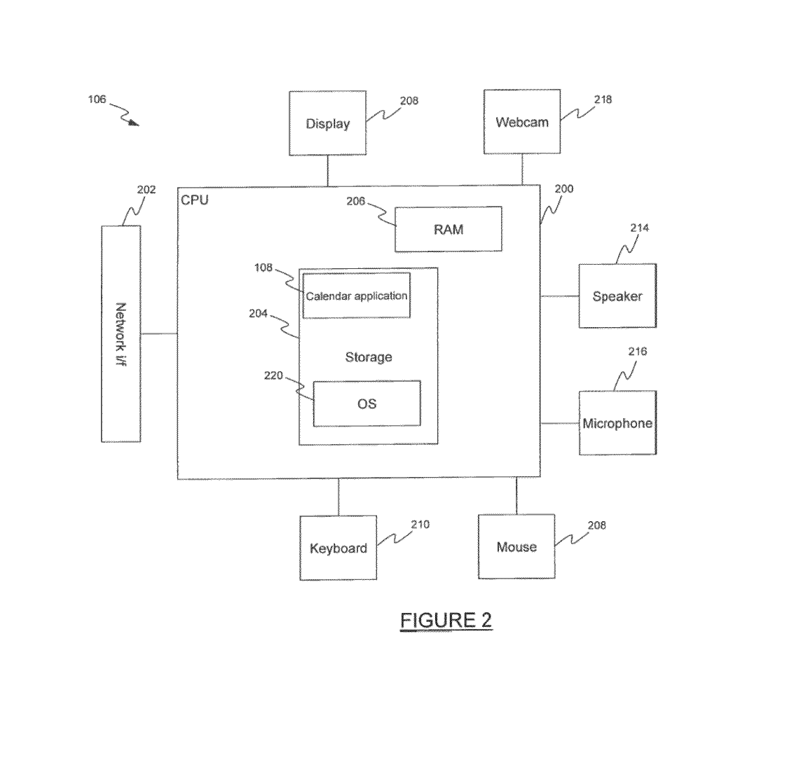

The schematic block diagram of FIG. 2 shows an example architecture of an end-user device 106. The end-user device 106 comprises a CPU 200 operatively coupled to: one or more network interfaces 202, such as modem for connecting to the Internet 104, and for connecting to the non-IP networks 110, a non-volatile storage device 204 such as a hard-drive or flash memory, and a volatile memory device such as a random access memory (RAM) 206. The end-user device 106 also comprises one or more user input devices, for example in the form of a keyboard 210, mouse 208, microphone 216 and webcam 218, each operatively coupled to the CPU 200. The end-user device 106 further comprises one or more user output devices, for example in the form of a display screen 208 and speaker 214, again each operatively coupled to the CPU 200. The keyboard 210, mouse 208, microphone 216, webcam 218, display screen 208 and speaker 214 may be peripheral devices, for example in the case of a PC, or integrated into the end-user device 106, for example in the case of a mobile device.

The storage device 204 stores software including at least an operating system (OS) 220 and the electronic calendar application software 108. The operating system 220 can run applications such as electronic calendar application software 108 by loading them into the RAM 206 and executing them on the CPU 200. To represent this in FIG. 2, the operating system 220 and electronic calendar application software 108 are shown within the CPU 200.

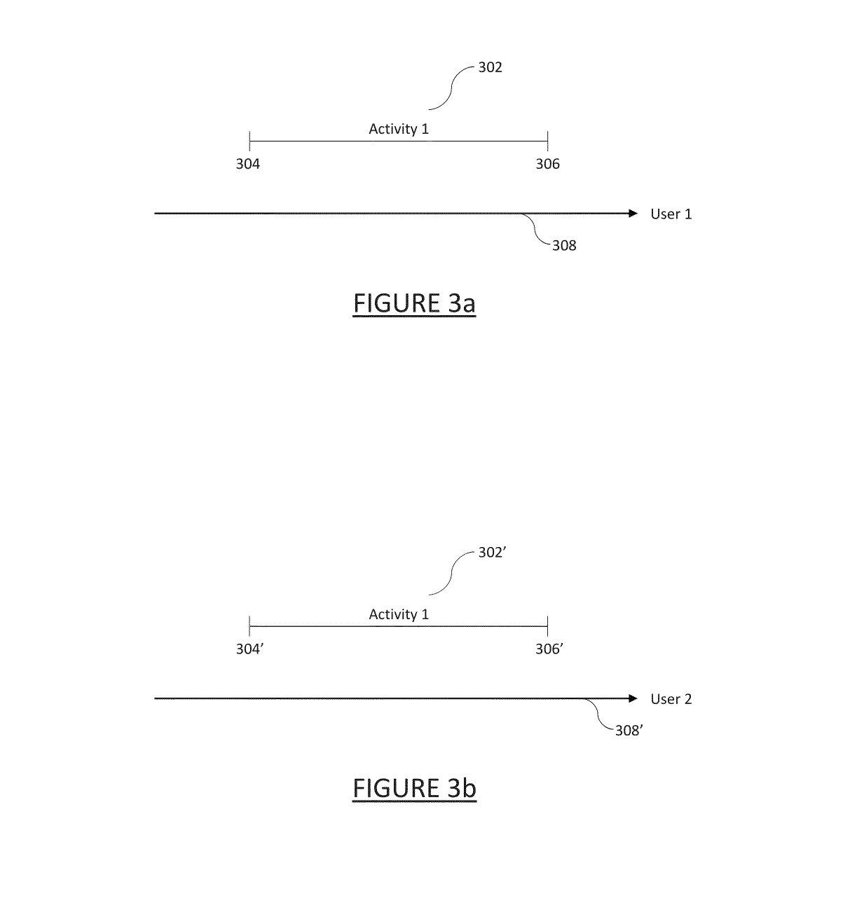

FIG. 3a shows a graphical representation of an activity that a user may enter details of into an end-user device 106 that is part of the electronic calendar system 100 as described in relation to FIG. 1. The activity has an identifier 302, in this case ‘Activity 1’, and a start and end time 304, 306. The activity sits on a user's timeline 308, in this case the timeline 308 is for ‘User 1’. At some stage, User 1 may select to invite another user e.g. User 2 to the Activity 1. By inviting User 2, data associated with Activity 1 is communicated from User 1's user device over a network (e.g. the Internet) to an electronic calendar server. Details of ‘Activity 1’ to which User 2 has now been invited may be stored in a calendar database associated with the electronic calendar server. When the User 2 is online (connected to the Internet), the stored information relating to ‘Activity’ is then retrievable by User 2 such that the stored information relating to ‘Activity 1’ can be received by an end-user device 106 associated with User 2.

In FIG. 3b shows a graphical representation of ‘Activity 1’, but now displayed on a timeline 308′ for User 2 (the invitee). As before, the ‘Activity 1’ is shown with an identifier 302′, as well as the start and end times for the ‘Activity 1’, 304′, and 306′. The identifier 302′, start time 304′ and end time 306′ information will be identical to the corresponding information that was shown in relation to User 1 (the inviter).

Together, FIGS. 3a and 3b represent the common situation in conventional electronic calendars when User 1 invites User 2 to an activity in User 1's electronic calendar. Note that there is no linkage between users, or activities and users. As such, the decision of a user to attend an activity, or not, has no impact on the occurrence of the activity (outside of cosmetic purposes).

### Constraint System

The present invention introduces a semantic layer into the electronic calendar system. Specially, User 1 sets one or more constraints for an activity (e.g. ‘Activity 1’) which define the conditions under which the activity can take place.

The introduction of the semantic layer creates an entirely new system to that in conventional electronic calendars, because it creates directional links from activities to users, and users to activities (in fact the links are from any element to any other element, and this will be expanded upon later). The key points of the semantic layer are:
The links from one element to another are directional, and provide the mechanism to ascertain which activities are visible to which users. These links are conditional, and may be active or inactive depending on the state of the activity and constraints to which they are directly connected.
The constraints do not need to explicitly mention specific elements. If they do not explicitly mention specific elements then they can mention elements in aggregate, or refer to external factors such that no elements of the system are directly involved in the constraint
Constraints manage multiple factors in an activity: if it is happening, who is attending, and in what capacity

The following text and figures provide more detail on these key points of the semantic layer.

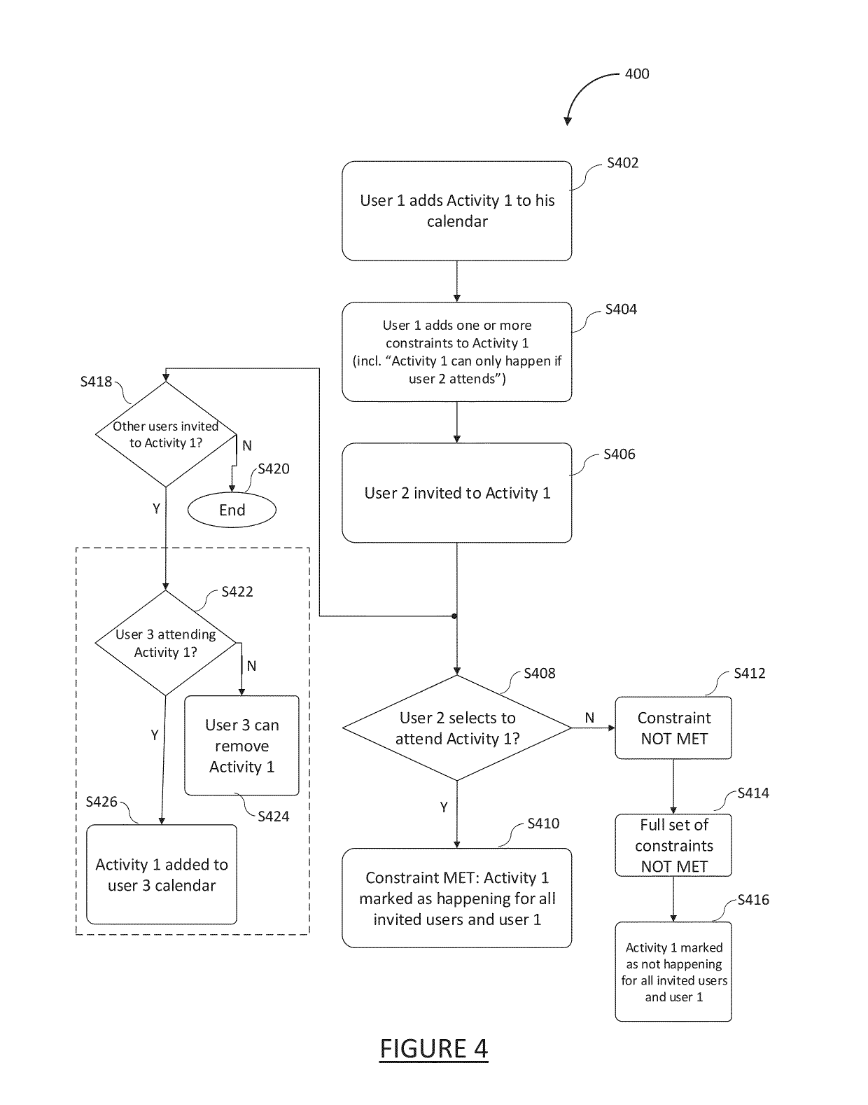

Reference is now made to FIG. 4 which shows a process flow 400 summarising a first embodiment where there is a constraint on user 2. The constraint on user 2 states that an activity can only take place on condition that user 2 chooses to attend that activity. The constraint on user 2 causes a link to form from the activity to the user to which the condition applies. It is this link which causes the activity to be entered into user 2's timeline 308′ and displayed on a user interface (e.g. a screen) of an end-user device 106 that user 2 has access to. Specifically referring to the steps of FIG. 4, the process starts at step S402 where user 1 adds an activity (‘Activity 1’) to his electronic calendar. Details of ‘Activity 1’ including its name, times and location may be stored locally in memory 204 at user 1's end-user device. These details are also stored remotely at the electronic calendar database 116 by the user device 106 sending the details over the Internet 104 to the electronic calendar server 102.

At step S404 user 1 adds one or more constraints to Activity 1 including the constraint “Activity 1 can only happen in user 2 attends”. By defining a constraint in relation to a particular user (user 2), this causes the electronic calendar server 102 to automatically associate the details of ‘Activity 1’ with user 2's electronic calendar. Thus, at step S406 when user 2 is online, their end-user device 106 will update to show the Activity 1 in their electronic calendar. In this way, user 2 has been invited to Activity 1 by user 1.

At step S408 the user decides whether or not to accept the invitation to attend Activity 1. If user 2 selects Yes to attend Activity 1 (User choice: ATTENDING), then at step S410 the electronic calendar server 102 determines that the constraint “Activity 1 can only happen if user 2 attends” as set by user 1 has been met (constraint MET). The selection by a user whether or not to attend an activity can be made by selecting a control displayed in a user interface of the electronic calendar shown by display 218, or by providing an audio instruction using microphone 216. Activity 1 is marked as happening by the server and optionally at the local memory of an end-user device 106 for user 2. It is also noted that because the constraint that User 2 must attend has been met, the electronic calendar server 102 will mark Activity 1 as happening in the calendars for all other users invited to Activity 1, as well as user 1 who initially added Activity 1 to his calendar.

If at Step S408 user 2 selects to decline the invitation to attend Activity 1 (User choice: NOT ATTENDING), the electronic calendar server 102 is updated at step S412 where it determines that the constraint “Activity 1’ can only happen if user 2 attends” as set by user 1 has not been met (constraint NOT MET). As the constraint set by user 1 defines that user 2 must attend for Activity 1 to happen, any other secondary constraints that user 1 may have set are overridden such that the full set of constraints for Activity 1 are marked as NOT MET at step S414. At step S416 the electronic calendar server 102 marks the event as not happening for all users that have been invited to Activity 1. For example Activity 1 may be shown in a user's electronic calendar as highlighted, or in strike-though, drawing the user's attention to the fact that Activity 1 can no longer happen. A user may then manually remove Activity 1 to stop it showing in their electronic calendar.

It should be noted that even after user 2 has indicated whether or not he will attend Activity 1 at step S408, user 2 may change his mind and indicate that he will not attend Activity 1, such that the Activity 1 will be marked as not happening for all users despite previously being marked as happening (i.e. when user 2 changes his indication from ATTENDING to NOT ATTENDING) or vice versa (i.e. when user 2 changes his indication from NOT ATTENDING to ATTENDING). In the latter case, even though another user may have removed the event from appearing in their electronic calendar, the electronic calendar server 102 will update such that it causes that user's calendar to be updated showing that Activity 1 is happening again. In this way, other invitees are less likely to miss out on activities.

Also, user 1 may update the one or more constraints associated with Activity 1. In this case the electronic calendar server 102 will be updated accordingly and the invitees to Activity 1 will be made aware of changes that may affect whether the Activity 1 is now set to happen or not. For example, if user 2 had already declined the invite causing Activity 1 to be marked as not happening for all invitees, but the user 1 subsequently removes the constraint “Activity 1’ can only happen if user 2 attends”, then the electronic calendar server 102 will be updated to ensure that the calendars for all invitees are updated with Activity 1 clearly shown marked as happening.

The branch at FIG. 4 from Step S418 is an optional branch that shows that other invitees, i.e. other than user 2, may be invited to join Activity 1. If there are no other invitees, this branch of the process 400 ends at step S420. If it is determined that there are other invitees, e.g. a third user, user 3, at step S422 user 3 can indicate whether or not he will attend Activity 1. If user 3 decides to decline the invitation to Activity 1, he may select to fully remove the event from his electronic calendar at step S424. On the other hand, if user 3 decides to attend Activity 1, this will be shown and marked as happening in his electronic calendar at step S426. However, as described above the Activity 1 could be marked as not happening and/or marked as happening again by the electronic calendar server 102, in dependence on whether or not the set of constraints are met by user 2. The steps of process flow 400 shown within the dashed line represent that these steps may be performed for any number of other users. For example these steps can be repeated in parallel for user 4, user 5, user 6 and so on.

The repercussion of user 2's choice to not attend Activity 1 is that the Activity 1 constraints are resolved to state that the activity is not happening. Even if another invitee, e.g. user 3, has stated that they are attending, the electronic calendar server 102 will provide information that even though user 3 has stated that they wish to attend, Activity 1 is not, at this time, happening and user 3's calendar will be updated by electronic calendar server 102 accordingly.

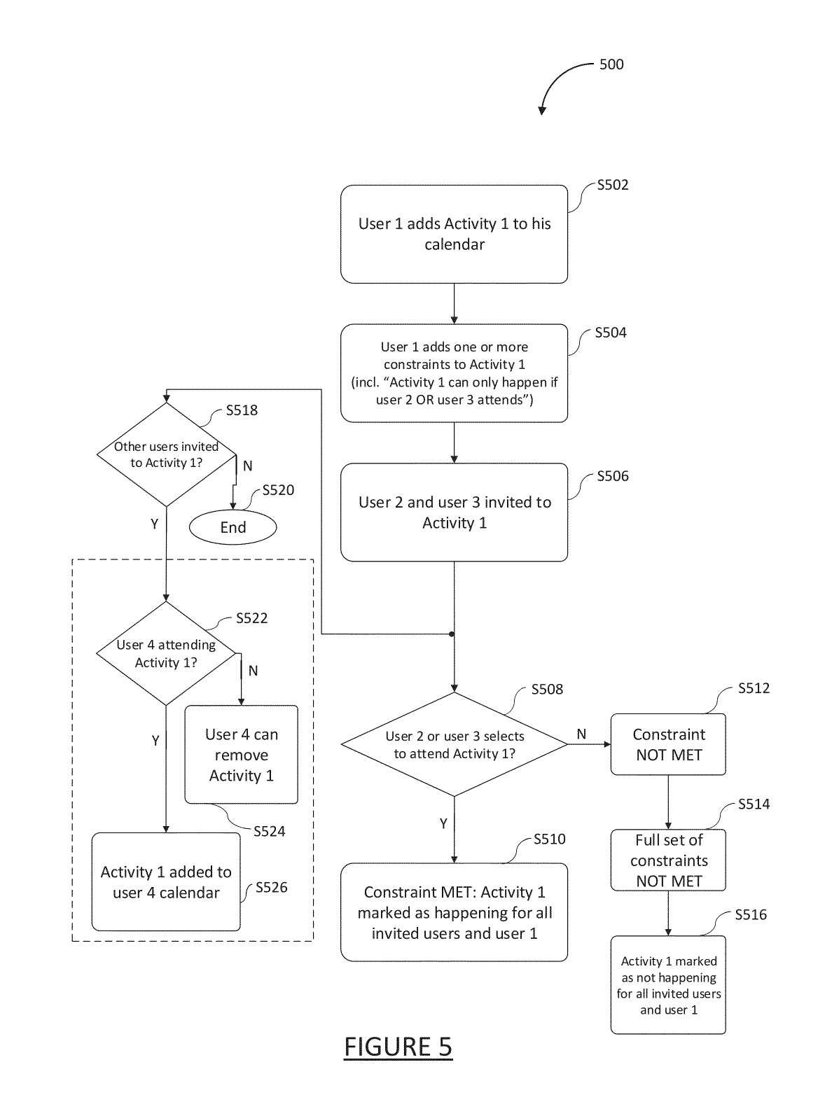

FIG. 5 shows a process flow 500 summarising a second embodiment of the present invention where there is a more complex constraint on user 2. Here, user 1 sets an OR constraint that states that an activity (e.g. Activity 1) will happen only if either of two particular users attend e.g. user 2 and user 3. At this point it is very important to stress that there is no requirement for user 2 and user 3 to be related; they do not need to be known to each other or communicate with each other in any way to resolve the state of activity 1. This allows the present invention to manage constraints which would not be possible with not only any conventional electronic calendar but any manual method of carrying out an equivalent function.

FIG. 5 is similar to FIG. 4 except that at step S504, user 1 sets the OR constraint that “Activity 1 can only happen if user 2 OR user 3 attends”. This causes the electronic calendar server 102 to send an invitation with details of Activity 1 to users 2 and 3 at step S506. If at Step S508 at least one of user 2 and user 3 select, independently of one another, Yes to attend Activity 1 (User choice: ATTENDING), then at step S510 the electronic calendar server 102 determines that the constraint “Activity 1’ can only happen if user 2 OR user 3 attends” been met (constraint MET). Activity 1 is marked as happening in the electronic calendar server 102 and optionally at the local memory 204 of an end-user device 106 for user 2. It is also noted that because the constraint that User 2 or user 3 must attend has been met, the electronic calendar server 102 will mark Activity 1 as happening in all calendars of users invited to Activity 1, and for user 1 who initially added Activity 1 to his calendar.

If at step S508 both users 2 and 3 declined the invitation to attend Activity 1 (User choice: NOT ATTENDING), the electronic calendar server 102 is updated at step S512 where it determines that the constraint “Activity 1’ can only happen if user 2 OR user 3 attends” has not been met (constraint NOT MET). As the constraint set by user 1 defines that user 2 or user 3 must attend for Activity 1 to happen, any other secondary constraints that user 1 may have set are overridden such that the full set of constraints for Activity 1 are marked as NOT MET at step S514. At step S516 the electronic calendar server 102 marks the event as not happening for all users that have been invited to Activity 1. For example Activity 1 may be shown in a user's electronic calendar as highlighted, or in strike-though, drawing the user's attention to the fact that Activity 1 can no longer happen. A user may then manually remove Activity 1 to stop it showing in their electronic calendar.

As before, even after user 2 and 3 have made their decisions about whether or not to attend Activity 1 at step S508, user 2 and/or user 3 can change their mind such that the Activity 1 may still be marked as not happening for all users despite previously being marked as happening (i.e. at a time when both user 2 and user 3 have decided to NOT ATTEND). Conversely both user 2 and user 3 may have selected to not attend Activity 1, but subsequently, one or both of user 2 and user 3 select to attend. In the latter case, even though another user may have removed the event from appearing in their electronic calendar, the electronic calendar server 102 can update such that it causes that user's calendar to be updated showing that Activity 1 is happening again i.e. Activity 1 is reinstated to their calendar. In this way, other invitees are less likely to miss out on activities.

Again, user 1 may update the one or more constraints associated with Activity 1. In this case the electronic calendar server 102 will be updated accordingly and the invitees to Activity 1 will be made aware of changes that may affect whether the Activity 1 is now set to happen or not.

As previously, the branch at FIG. 5 from Step S518 is an optional branch that shows that other invitees, i.e. other than user 2 and user 3, may be invited to join Activity 1. If there are no other invitees, this branch of the process 500 ends at step S520. If it is determined that there are other invitees, e.g. a fourth user, user 4, at step S522 user 4 can indicate whether or not he will attend Activity 1. If user 4 decides to decline the invitation to Activity 1, he may select to fully remove the event from his electronic calendar at step S524. On the other hand, if user 4 selects to attend Activity 1, this will be shown and marked as happening in his electronic calendar at step S526. However, as described above the status of Activity 1 can be changed and marked as not happening and/or marked as happening again by the electronic calendar server 102, in dependence on whether or not the OR constraint is met by user 2 and user 3. The steps of process flow 500 shown within the dashed line represent that these steps may be performed for any number of other users. For example these steps can be performed in parallel for user 5, user 6, user 7 and so on.

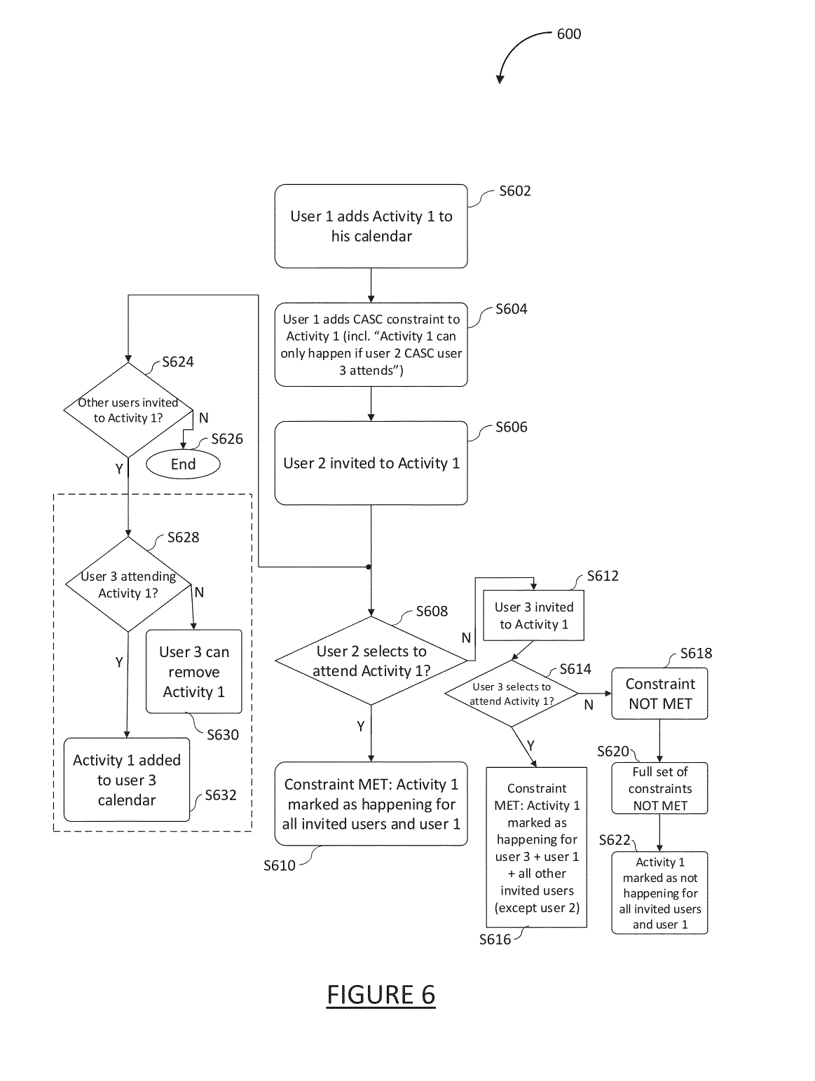

FIG. 6 shows a process flow 600 summarising a third embodiment of the present invention where there is an even more complex constraint on user 2. Here, user 1 sets a cascade (CASC) constraint which is similar to the OR constraint seen in FIG. 5 in that it requires one of two users to attend, but in this case there is an implicit preference for user 2 over user 3. This manifests itself in the activity (e.g. Activity 1) being invisible to user 3 until user 2 has decided on their attendance.

As previously, the process 600 starts by user 1 adding Activity 1 to his electronic calendar at step S602. User 1 then sets the CASC constraint for Activity 1 at step 604, causing the electronic calendar server 102 to invite only user 2 to Activity 1 at step S606. At this point, the Activity 1 is completely invisible to user 3. If at step S608 user 2 selects to attend Activity 1 (User choice: ATTENDING), then the electronic calendar server 102 determines that the CASC constraint has been met at step S610. Because the CASC constraint has been met without requiring user 3 to make a decision on their attendance, user 3 never sees the Activity 1 in their electronic calendar. Activity 1 is therefore marked as happening by the electronic calendar server 102 for the calendars of user 1 and user 2, and for any other invitees (users) to Activity 1 (see the process branch from step S624).

If at step S608 user 2 decides not to attend the Activity 1, then because the CASC constraint has not been met without requiring user 3 to make a decision on their attendance, Activity 1 now becomes visible to user 3 at step S612. Again, it is important to stress the fact that there is no requirement for user 2 and user 3 to be known to each other, and indeed in this situation user 3 will not know that their request for attendance was dependent on user 2's attendance.

It is also important to note that although user 2 has made a decision not to attend Activity 1, the CASC constraint is yet to be marked as either MET or NOT MET. Once user 3 makes a decision on attendance at step S614, enough information will be present at the electronic calendar server 102 to mark the constraint as either MET (step S616) or NOT MET (S618).

If user 3 selects not to attend then the CASC constraint is marked as NOT MET meaning that the full set of constraints is marked as NOT MET at step S620. In this case electronic calendar server 102 marks Activity 1 as not happening in the electronic calendar for all respective users who had been invited to Activity 1.

Again, user 1 may update the one or more constraints associated with Activity 1. In this case the electronic calendar server 102 will be updated accordingly and the invitees to Activity 1 will be made aware of changes that may affect whether the Activity 1 is now set to happen or is now is now no longer set to happen.

As previously, the branch from Step S624 is an optional branch that shows that other invitees, i.e. other than user 2 and user 3, may be invited to join Activity 1. If there are no other invitees, this branch of the process 600 ends at step S626. If it is determined that there are other invitees, e.g. a fourth user, user 4, at step S624, user 4 can indicate whether or not he will attend Activity 1 at step S628. If user 4 selects to decline the invitation to Activity 1, he may then select to fully remove the event from his electronic calendar at step S630. On the other hand, if user 4 decides to attend Activity 1, Activity 1 will be shown and maintained by the electronic calendar server 102 for his electronic calendar at step S632. However, as described above the Activity 1 could be marked as not happening by the electronic calendar server 102, in dependence on the CASC constraint result being NOT MET. The steps of process flow 600 shown within the dashed line represent that these steps may be performed for any number of other users. For example these steps can be repeated in parallel for user 5, user 6, user 7 and so on.

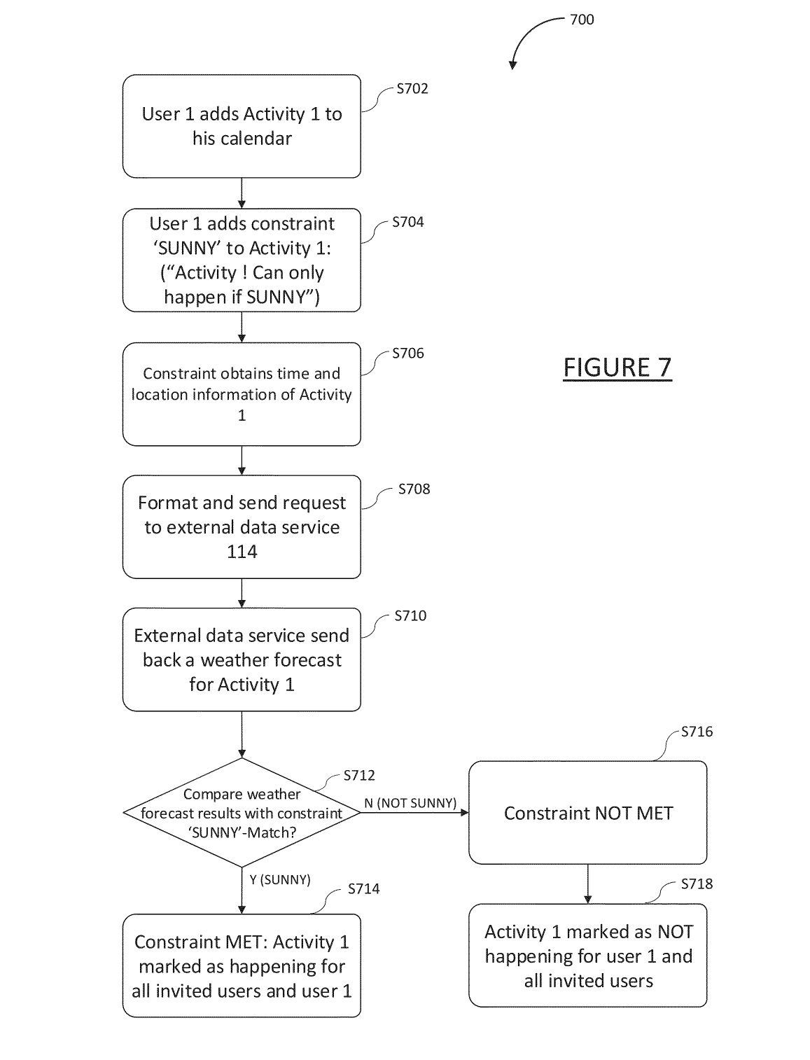

With reference to FIG. 7, a different type of constraint is now introduced in process 700. The constraint SUNNY will only be met if the weather forecast for the location where an activity (e.g. Activity 1) will be undertaken is considered sunny between the start time 304 and end time 306 of the activity. To check this constraint the present invention takes information about the time of the activity and the location at which it will take place and uses this to interact with an external data service 114, in this case another computer which provides weather information, to obtain a weather forecast. Once it obtains this information it will decide if the weather meets the constraint and alter the status of the activity accordingly.

Process 700 starts at step S702 where user 1 adds Activity 1 in his electronic calendar. At step S704, user 1 sets a constraint for Activity 1 as SUNNY (“Activity 1 can only happen if SUNNY”). The constraint is configured so that at step S706 it obtains the required information from Activity 1, in this case the time and location details of Activity 1. At step S708 this information is then formatted in to a suitable from and sent as a request to the external data service 114, in this case a weather forecasting service. The steps S706 and S708 may be performed by the processor 200 on the local end-user device 106 being used by user 1, or alternatively by the remote electronic calendar server 102. At step S 710 the external data service 114 sends a data result back to the entity that sent the request, in this case the data result is a weather forecast for the time and location of Activity 1. At step S712 the requesting entity (i.e. local processor 200 or electronic calendar server 102, as appropriate) compares the received weather forecast data result with the constraint SUNNY to determine whether or not he constraint matches with the weather forecast data result. Weather forecast data is received from a weather forecasting service in a format which includes a status code which indicates a particular weather state. For example, status codes can be numbers (1, 2, 3, etc.) which correspond to particular weather states (fine, sunny, rainy, etc.). The weather constraint which is set by a user on the event is converted into a corresponding status code according to the weather forecasting service. In that way, the constraint can be matched to the appropriate status code depending on the forecasting service. Thus, it is possible to compare at the server, the status code corresponding to the constraint to the status code delivered by the weather forecasting service to see if there is a match. Different weather forecasting services use different weather status codes, and therefore it may be necessary for the server to have more than one status code for each weather state, If there is a match, i.e. the constraint is set to SUNNY and the weather forecast for the time and location of Activity 1 is sunny, then the constraint SUNNY is marked as MET and Activity 1 is marked as happening in the calendars for all users invited to Activity 1 and for user 1 who initially added Activity 1 to his calendar. Note that if the local processor 200 of end-user device 106 was used to send the request and compare the received data result from the external data service 114, then a message indicating that the constraint is marked as MET is sent from the end-user device 106 to the electronic calendar server 102 prior to step 714.

If at step S712 it is determined that the constraint SUNNY does not match with the weather forecast data result, then at step S716 the constraint SUNNY is marked as NOT MET. For example, the weather forecast data result may indicate that the weather forecast for Activity 1 is due to be cloudy or rainy. It follows that Activity 1 therefore cannot take place. Again, if end-user device 106 is used to determine the constraint SUNNY is not met, then a message indicating that the constraint is marked as NOT MET is sent from the end-user device 106 to the electronic calendar server 102 prior to step 714. At step S718 electronic calendar sever 102 marks Activity 1 as not happening in the electronic calendar of each respective user (invitee) that had been invited to Activity 1.

It should be stressed that the constraint SUNNY is just for the purposes of this example, and the present invention allows for any constraint which can obtain information from a source inside or outside of the invention, using the information available from the activity and the user as well as from any or all of the attendees of the activity. As another example of a weather-related constraint, user 1 may set a temperature threshold constraint e.g. “Activity 1 can only happen if weather is going to be 20° C. or higher”.

It should also be noted that constraints are continually re-evaluated as details about the activity and/or constraint changes. Further, the weather forecast might change from sunny to cloudy, or vice versa, and the status of the activity will update accordingly e.g. if the weather forecast changes from sunny to cloudy then the constraint for Activity 1 previously marked as MET will change to NOT MET causing Activity 1 to now be marked as not happening. To prevent the status of Activity 1 changing too often, user 1 can select how often the status may be updated. For example user 1 can set a control that limits the electronic calendar server 102 to updating the status of the event a set number of times within a defined period, and/or at particular times e.g. three times in twenty-four hours, or at 5 pm every other day.

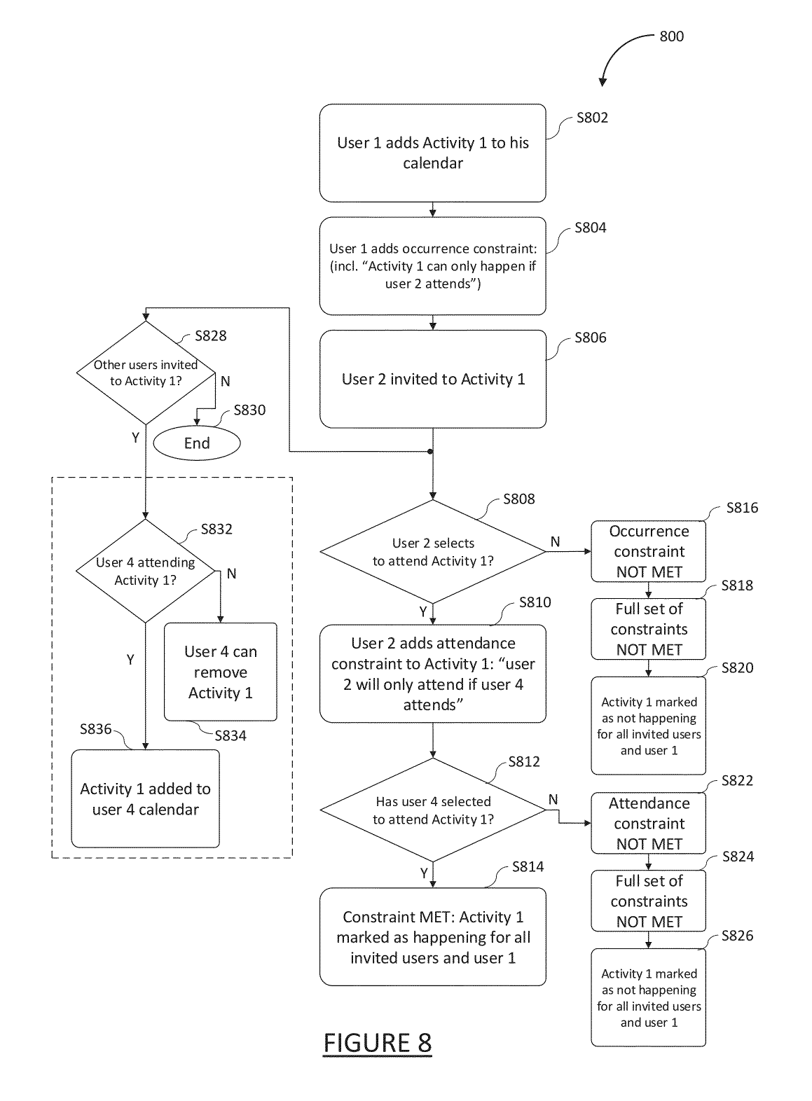

With reference to FIG. 8, the concept of “attendance constraints” is introduced. Process flow 800 starts with the familiar scenario described in FIG. 4. User 1 adds Activity 1 to his calendar (step S802) and then sets an “occurrence constraint” for Activity 1 such that Activity 1 will only happen (i.e. occur) if user 2 attends (step S804). The electronic calendar server 102 is thus caused to invite user 2 to Activity 1 such that Activity 1 now appears in user 2's electronic calendar (step S806). At step S808 user 2 selects whether or not to attend Activity 1. Rather than a simple yes/no selection for whether or not user 2 attends Activity 1, user 2 selects to attend but only on condition that another particular user, e.g. user 4, will also attend Activity 1. Therefore at step S810 user 2 has added their own constraint, which is an “attendance constraint” (“User will only attend Activity 1 if user 4 attends Activity 1”).

It is important to differentiate between occurrence constraints and attendance constraints. An occurrence constraint is a constraint on an activity occurring; if occurrence constraints are not met then the activity will not happen (will not take place). An attendance constraint is a constraint on a specific user attending an activity; if attendance constraints are not met then that particular user will not attend the activity.

Occurrence constraints can only be created and maintained by the user who creates the activity itself i.e. in the above examples, an occurrence constraint for Activity 1 may only be created and maintained by user 1. Attendee constraints can be created by anyone who has been invited to attend the activity (including the creator), which can in turn link to further attendees who may then set their own constraints.

Returning to FIG. 8, in response to user 2 adding the attendance constraint to Activity 1 for user 4 at step S810, the electronic calendar server 102 now checks to see if user 4 has indicated that he will attend Activity 1 (step S812). If step S812 determines that user 4 has indicated that he will attend Activity 1 (User choice: ATTENDING), then at step S814 the electronic calendar server 102 marks both the attendance constraint added by user 2 and the initial occurrence constraint added by user 1 as MET. Therefore all constraints are met and so Activity 1 is marked as happening by the electronic calendar server 102 for the calendars for all users invited to Activity 1, and user 1 who initially added Activity 1 to his electronic calendar.

If at step S808 user 2 declines the invitation to Activity 1, then the occurrence constraint is marked NOT MET at step S816. Thus the full set of constraints is marked as NOT MET (step S818) and Activity 1 is marked as not happening by the electronic calendar server 102 at step S820, for all users invited to Activity 1 and user 1 who created Activity 1.

Similarly, if at step S812 the electronic calendar server 102 determines that user 4 is NOT ATTENDING then attendance constraint added by user 2 is marked as NOT MET by the electronic calendar server 102 at step S822. Thus the full set of constraints is marked as NOT MET (step S824) and Activity 1 is marked as not happening by the electronic calendar server 102 at step S826, for all users invited to Activity 1 and user 1 who created Activity 1.

As previously, the branch showing steps S828 to S836 represent the process undertaken by the electronic calendar server 102 to determine whether or not there are any other users (including user 4) that have been invited to Activity 1 and whether they have indicated whether or not they plan to attend. As before, the dashed line represents that these steps of process 800 may be repeated in parallel for any number of other users that have been invited to Activity 1.

Also, similar to previous embodiments, the electronic calendar server 102 can continually monitor whether changes to the occurrence constraint by user 1 or changes to the attendance constraint by user 2 are made such that will allow for the status of the Activity 1 to be updated. That is the constraints may change from NOT MET to MET such that an activity previously marked as not happening can now be marked as happening, or vice versa.

Attendance constraints may be set by users to indicate that they will attend a particular activity only if the attendance constraint is marked as met. That is, rather than marking an activity as not happening for all attendees and invitees as in the case when occurrence constraints are marked NOT MET, when an attendance constraint is marked as NOT MET, activity will only be removed from the electronic calendar of the particular user that set the attendance constraint. This way, the activity can still happen and remains in the electronic calendar of each of the other attendees and invitees.

It should also be understood that other types of attendance constraint than the one described in the process flow of FIG. 8 are possible. For instance user 1 may set an attendance constraint of SUNNY, similar to that described in relation to FIG. 7. For example user 1 may set the attendance constraint “User 1 will only attend Activity 1 if SUNNY”. Therefore, if it is determined that the weather for Activity 1 is going to be sunny (as described above), this attendance constraint is marked as MET and Activity 1 is maintained in user 1's electronic calendar. On the other hand if the weather forecast data indicates that the weather for Activity 1 is not going to be sunny, then the attendance constraint is marked as NOT MET and Activity 1 may be removed from user 1's electronic calendar, either automatically by the electronic calendar application software 108 or manually by the user.

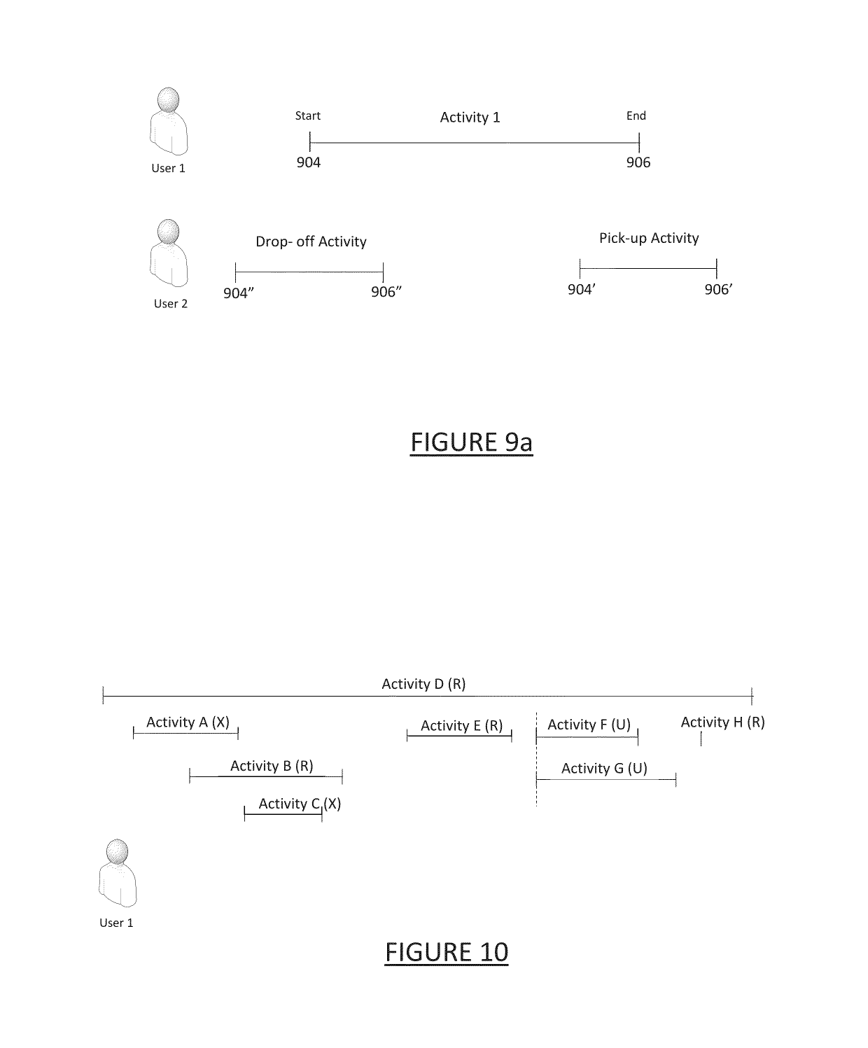

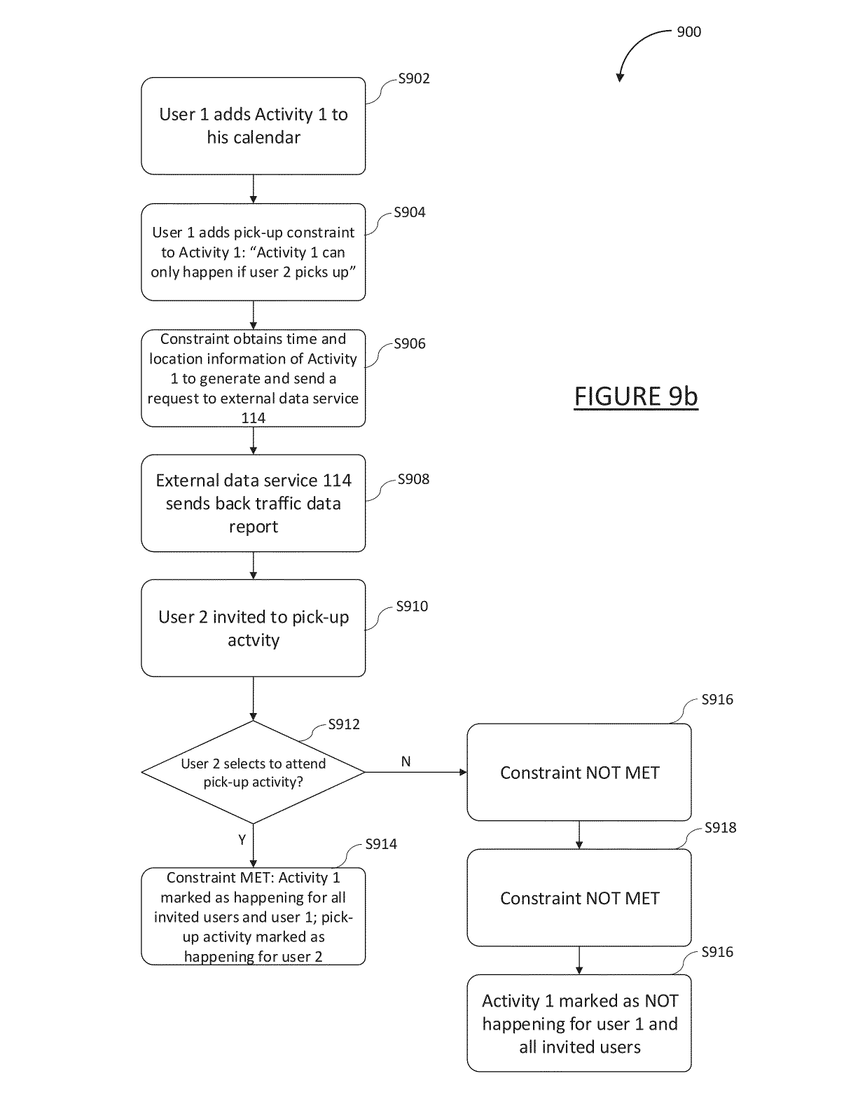

FIG. 9a introduces the concept of pick-up and drop-off constraints. These are a separate category of constraint to those introduced previously because they utilise implicit knowledge to ascertain if they can be met or not. Implicit knowledge is defined as knowledge obtained by the calendar system, as opposed to knowledge which is supplied directly by user interactions with the system.

In this case the occurrence constraint for the activity depends not on user 2's ability to attend an activity (e.g. Activity 1) but their ability to pick up someone at the end of the activity 906. Hence, although Activity 1 runs for a specific amount of time as shown by timeline 908 (which is associated with user 1), the pick-up constraint means that user 2 only sees a part of Activity 1 which is relevant for them. Specifically, user 2 sees a period of time (the “pick-up activity”) with a start time 904′ and end time 906′ around the end time 906 of Activity 1 which user 2 will need to dedicate to traveling to and returning from the location of Activity 1. Alternatively or in addition this example can apply to a drop-off constraint whereby user 2 sees a period of time (the “drop-off activity”) with a start time 904″ and end time 906″ around the start time 904 of Activity 1 which user 2 will need to dedicate to traveling to and returning from the location of Activity 1.

Pick-up and drop-off constraints can optionally obtain dynamic traffic information based on user and activity locations to be able to provide implicit knowledge about the time required around the start and/or end times of an activity. This is reflected in the start and end times of the pick-up and/or drop-off activity. The step of a pick-up constraint and/or a drop-off constraint obtaining dynamic traffic information is performed by either of the local processor 200 of end-user device 106 or the electronic calendar server 102 which may be configured to generate and send a request with the time and location information for Activity 1 to an external data service 114, in this case a traffic monitoring service. The external data service 114 generates a live traffic data report based on the provided time and location information and sends this back to the requesting entity (i.e. the local processor 200 or the electronic calendar server 102).

FIG. 9b shows a process flow 900 for utilising a pick-up constraint. Note that the following embodiment is equally applicable to utilising a drop-off constraint.

At step S902 user 1 adds Activity 1 to his electronic calendar. At step S904, user 1 sets a pick-up constraint for Activity 1 such that “Activity 1 can only happen if user 2 picks up”. Optionally, at step S906, the local processor 200 or electronic calendar server 102 obtains time and location information from Activity 1, in particular regarding the pick-up time, in order to generate and send a request to external data service 114 (traffic monitoring service) for a traffic report. At step S908 the external data service 114 sends back a traffic data report to the entity that sent the request. Note that if traffic information is not relevant to the pick-up constraint, then steps S906 and S908 can be bypassed. At step S910, the electronic calendar server 102 is caused to invite user 2, specifically by providing information on the location and the pick-up start time and end time that is relevant for user 2. If dynamic traffic data for the pick-up activity was obtained at steps S906 and S908, this information is factored into determining the pick-up activity's start and end times provided to user 2 and displayed in their electronic calendar. At step S912 user 2 can either select to attend the pick-up or decline the pick-up activity. If the user selects Yes, to attend the pick-up activity, then the pick-up constraint is marked MET and Activity 1 is marked as happening by the electronic calendar server 102 in the calendars for all users invited to Activity 1, while the pick-up period is marked as happening for the user 2 who is only concerned with picking up after Activity 1 has ended.

If at step S912 user 2 selects to decline the pick-up, then the pick-up constraint is marked as NOT MET at step S916. In this case the full set of constraints are marked as NOT MET at step S918 and the electronic calendar server 102 marks Activity 1 as not happening for all invited users. The electronic calendar server 102 can continually monitor for changes to the Activity time and location, as well as updates based on the dynamic traffic data, to ensure that the pick-up activity information provided to user 2 remains accurate and up-to-date. Further, the electronic calendar server 102 can monitor for changes to the pick-up constraints set by user 1 and/or whether user 2 indicates that at step S912 that he has changed his indication on whether or not he is able to attend the pick-up activity. In this way the pick-up constraint may be changed from NOT MET to MET such that Activity 1 which was previously marked as not happening by the electronic calendar server 102 can now be marked as happening by the electronic calendar server 2. The reverse situation where the pick-up constraint was marked as MET and is changed to NOT MET is also possible as would be understood by the skilled person.

### Conflict Resolution

Discussion now moves on to conflict resolution. A conflict occurs when two or more activities are scheduled at the same time. As a user can only attend a single activity at one time, this situation needs to be resolved so that it is clear to the user exactly which activities the user is attending, and which they are not. This also feeds back in to the constraint system to allow for constraints dependent on the user's attendance to be resolved.

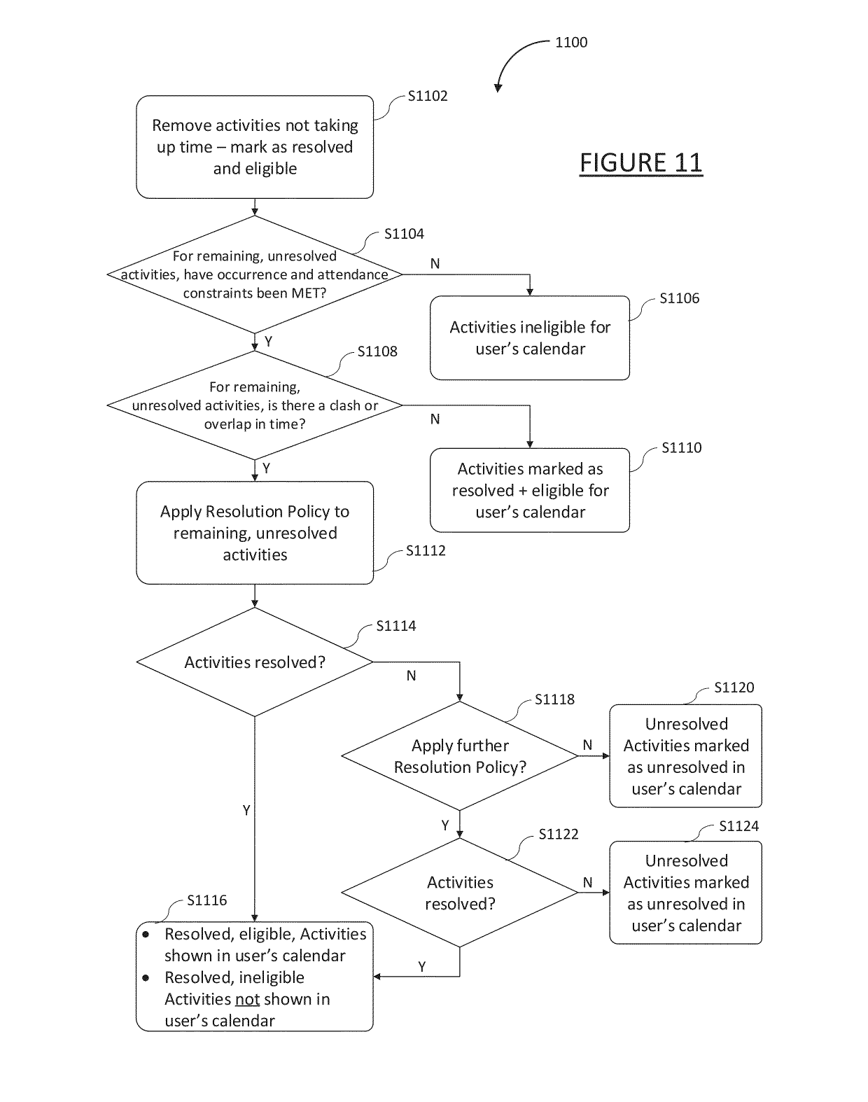

FIG. 10 shows a graphical representation of a set of activities 1000 labelled Activity A through to Activity H for a particular user (e.g. user 1). The bar under each activity represents a length of time each with a start time and an end time. Some of the activities have been determined as resolved and eligible to appear in the user's electronic calendar (marked (R)), some of the activities have been determined to be ineligible to appear in the user's electronic calendar (marked (X)), while some are marked as unresolved (U). This conflict resolution determination process is explained with reference to FIG. 11.

FIG. 11 shows a conflict resolution process flow 1100 demonstrating how the conflict resolution is performed. Note that the conflict resolution may be performed at either the electronic calendar server 102 or by local processor 200 at an end-user terminal 106. In the latter case, the end-user terminal is configured to notify the electronic calendar server 102 so that updates to the user's calendar can be maintained centrally and accessed by that user from any suitable networked end-user device 106.

At step 1102 any activities which do not actually take up time are removed. Examples of such activities are reminders and holiday periods, where although they might be present over a period of time they do not signify that the time is unavailable to other activities. In the representative example shown by FIG. 10, Activity D was a holiday and Activity H was a reminder. Activities D and H are both marked as resolved (R) and these activities can appear in user 1's resolved electronic calendar.

At step 1104, each of the remaining, unresolved activities are examined to see if any occurrence and attendance constraints associated with the respective activity have been met or not i.e. marked as MET or NOT MET. For any activities for which constraint(s) have not been met, these are ineligible to be displayed in the user's resolved electronic calendar and so are removed at step S1106. In the representative example shown by FIG. 10, Activity A is determined to have one or more constraints that could not be met and therefore Activity A is ineligible to appear in the resolved calendar for user 1 and so is removed (marked (X)).

Next at step S1108, each of the remaining, unresolved activities i.e. activities determined as having no constraints or having constraints marked as MET at S1104, are examined to see whether or not they clash or overlap in time. If there is no clash or overlap in time for a given activity, then the activity is determined to be eligible to appear in the resolved electronic calendar at steps S1110. In the representative example shown by FIG. 10, Activity E is the only event which does not overlap with any other activities and so Activity E is marked as resolved and eligible (R).

Next at step S1112, each of the remaining, unresolved activities i.e. activities determined to have some degree of overlap in time at S1108, are attempted to be resolved automatically by applying a resolution policy. For the purposes for the example shown in FIG. 10, a very simple resolution policy is used that states that whichever activity starts first has priority. It should be noted that this is an example policy and each user can set one or more policies based on their own requirements. A resolution policy is semantically similar to a set of constraints as described above, except that the policy works against two or more activities to decide a winner rather than providing a simple met or not met result. As one example, a first activity (football game) is scheduled for 9-11 am on a particular date, and a second activity (tennis game) is scheduled for the same date but at 10-11 am. Thus the two activities clash or overlap in time. Both have a constraint that has been marked as MET (for instance both activities are set with the constraint SUNNY which is determined to have been met for both activities). The conflict resolution in the above example would then resolve the two activities by giving priority to the football game over the tennis game, because the football game is scheduled to start first.

Returning to FIG. 11, at step S1114, the result of the application of the resolution policy at S1112 is determined. If the activities are successfully resolved, then at step S1116 a determination is made that eligible activities will appear in the user's electronic calendar whereas ineligible activities will not appear in the electronic calendar.

When the example resolution policy is applied to the example scenario shown in FIG. 10, activity B and activity C are shown as resolved. Activity B (marked (R)) is resolved and is eligible to appear in user 1's electronic calendar because activity B started prior to activity C. Therefore activity C is resolved but is ineligible to appear in user 1's electronic calendar and so is marked (X).

If it is determined at step S1114 of FIG. 11 that the remaining, unresolved activities cannot be resolved by the resolution policy, then at step S1118 a determination is made as to whether there is a further resolution policy, different to the one applied at S1112 that can be applied to the unresolved activities. If there is no further resolution policy that can be applied then the unresolved activities remain unresolved. At step S1120 the unresolved activities are moved into the user's resolved electronic calendar, but with the unresolved activities clearly marked as unresolved (U).

In the example shown in FIG. 10, as activity F and activity G start at the same time, the example resolution policy is unable to resolve them. Thus if there is no other resolution policy to help resolve these activities, both activities F and G will be eligible to appear in user 1's resolved calendar but marked as unresolved (U).

If at step S1118 there is a further resolution policy that can be applied to unresolved activities, this will be automatically applied. At step S1122 a determination is made as to whether the further resolution policy has been able to successfully resolve the unresolved activities. If the further resolution policy successfully resolves the remaining activities, then the process 1100 loops back to step S1116 where a determination is made that eligible, resolved activities will appear in the user's electronic calendar whereas ineligible, resolved activities will not appear in the user's electronic calendar.

If the further resolution policy is still unable to resolve the remaining activities, then at step S1124, the unresolved activities are moved into the user's resolved electronic calendar, but with the unresolved activities clearly marked as unresolved (U).

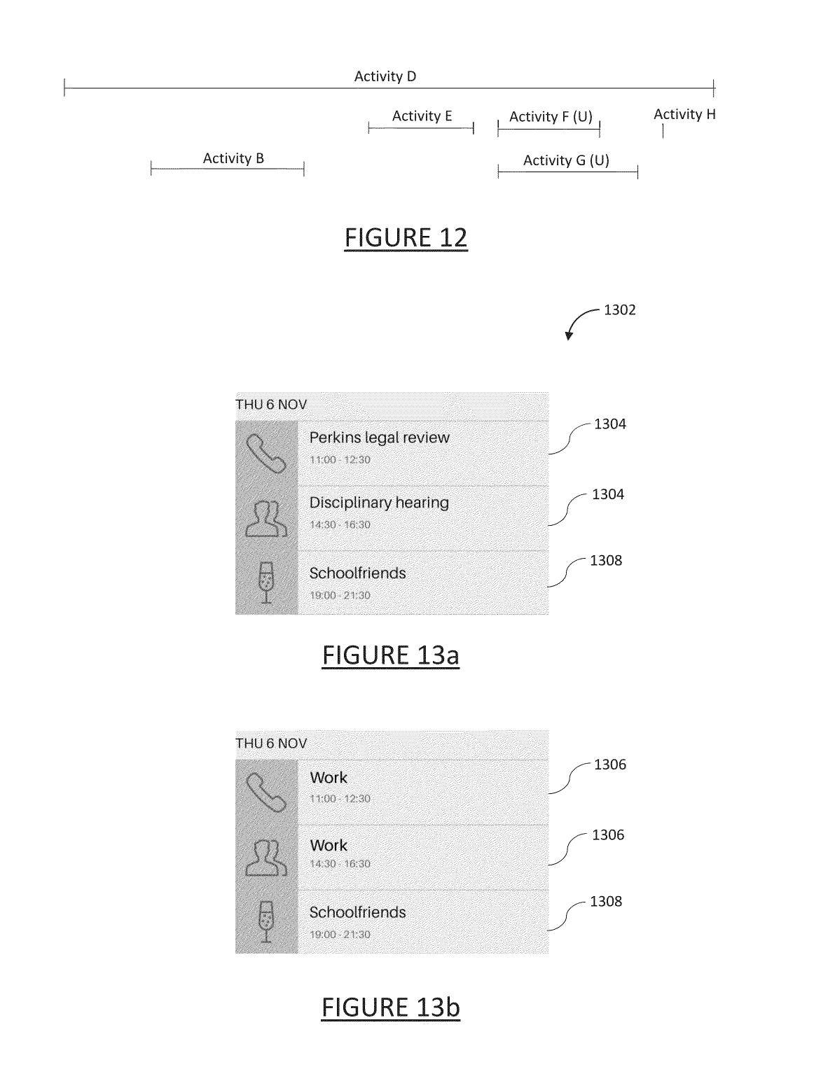

FIG. 12 shows the final resolved calendar for user 1. Note that activities A and C do not appear as they were determined to be ineligible to appear in the calendar. The resultant calendar will be available to the user and they will be able to provide further guidance as to how to resolve unresolved (U) activities F and G, either by manually selecting a specific resolution for these activities or by altering their resolution policy so that this and future similar scenarios will be resolved automatically.

### Other Embodiments

In addition to the above constraint and conflict resolution embodiments, the present invention contains a number of other features that use the semantic layer to provide abilities that are not possible to implement in traditional electronic calendars. These features as relating to the present invention are described in detail below.

### Redacted/Privacy

One common problem with traditional electronic calendars is that sharing of calendars is binary; either the calendar is totally invisible to another user or it is fully visible. As calendars often contain at least some information that can be considered private or confidential, this means that either calendars cannot be shared or users need to maintain multiple calendars in an attempt to separate the information.

One embodiment of the present invention provides a privacy service by allowing for selective sharing of activities within a calendar. A user might select specific activities or categories of activities that they declare as being private. Further, the user decides if the person with whom they are sharing the calendar should see no information at all about the private activity or if they should see a redacted activity that shows when the user is busy with the activity but provides no further details. This is especially important when different aspects of a user's life interact as shown in the following example.

FIG. 13a shows an example of a user's calendar 1302 containing confidential information 1304, in this case the calendar is associated with user 1. In one example scenario, user 1's spouse, user 2, wishes to arrange a lunch but needs to fit it around user 1's schedule. User 1 has granted user 2 the ability to see their calendar to aid scheduling of such activities, but user 1's calendar contains information from their workplace which is confidential.

As such, rather than the view as shown in 13a instead user 2 sees the view as shown in FIG. 13b. FIG. 13b shows the same information but with selective sharing applied. User 1 selects which activities in his calendar he only wants to selectively share with user 2 and/or any other users. The electronic calendar application software 108 at local end-user device 106 or the electronic calendar server 102 is effected to mask out confidential details of each activity, in this case replacing sensitive information of work activities with the simple word ‘Work’ 1306. This redacted version of the calendar is then shared with user 2 via the electronic calendar server 102 so that user 2 can schedule activities (e.g. social activities) with user 1, without user 1 giving away confidential information. Note that in FIG. 13b the non-work social activity ‘Schoolfriends’ 1308 has remained visible to user 2 as it does not contain confidential information.

By acting as a trusted intermediary between all users the present invention can provide enough information to individual users to enable co-ordinated scheduling without disclosing personal and confidential information.

The privacy service may be implemented by the electronic calendar server 102 and or the electronic calendar application software 108 at the end-user device 102. The privacy service works hand-in-hand with the Constraint Resolution embodiment, as described above, to ensure that the information visible to each user is pertinent without disclosing confidential details. When constraints have been set between users who do not have an immediate friend relationship, the information presented to a user depends on the type of activity as well as the status of the other user. For example, if user 1 works with user 2, and user 2 is married to user 3, and user 1 and user 3 are unknown to each other, then details of activities of user 1 constrained by user 2, who in turn is constrained on user 3, will be redacted. Providing a more concrete example, if user 1 has a business meeting that is constrained by user 2's attendance (i.e. “business meeting can only happen if user 2 attends”), and user 2 can only attend if user 3 can babysit for them (i.e. “user 2 can only attend business meeting if user 3 can babysit at the time of the meeting”), then user 3 will see a request for babysitting displayed in their electronic calendar at the time of the business meeting, but no details about the business meeting itself. In this way, the details of the business meeting remain private and confidential as between user 1 and user 2 as the electronic calendar server 102 and/or electronic calendar software application 108 are configured so that only these details can be displayed in the respective electronic calendars for user 1 and user 2.

### Importing

Another problem with traditional electronic calendars regards the ability to import another calendar and incorporate it in to your own calendar. Traditional electronic calendars provide two options: either the calendar is imported wholesale or retained as a reference. In the former case the user ends up with a point-in-time view of the calendar that has been imported, and any changes made after the time of import are not reflected in the user's calendar. This causes imported information to become out-of-date and results in erroneous information in the user's calendar. In the latter case the user sees all information within the referenced calendar and has no ability to select the activities that they want to see. This causes the user's calendar to fill up with information that the user does not wish to see so that they can maintain a view in to the one or two items they do wish to see. Due to both options having considerable drawbacks most users use neither option and instead opt to attempt to keep the information in their calendar up to date manually.

One embodiment of the present invention provides a new mechanism of sharing and aggregating calendars from multiple sources. Firstly, reference of other calendars is selective and works on the basis of either individual activities or groups of activities based on the information within that activity and specifically within the semantic layer of that activity. For example, a user who wants to subscribe to a football club's calendar but only wishes to see the home games may do so. For example, the user can implement the electronic calendar application software 108 running at a local end-user device 106 to cause the user to become a subscriber to a third party external data service 114, in this case a third party calendar service that creates and maintains electronic calendar activities (e.g. the third party calendar service may be a server that hosts data for the football club the user is interested in subscribing to). The electronic calendar server 102 will receive updates from the external data service 114 so that the individual users that subscribe to a particular third party calendar service will then be able to receive updates at their connected end-user device 106. In the above example, the electronic calendar application software 108 will cause the end-user device to check the electronic calendar for updates that can be retrieved. Alternatively, the electronic calendar 102 may be configured to push new activity data to the connected end-user device associated with the subscribed user. Thus, taking the above example, any changes to the football club's calendar will be accurately reflected in the user's calendar.

Secondly, an embodiment of the present invention allows the user to manage the imported activities individually. Each imported activity is considered an equal to activities to which the user has been invited, or that the user themselves has created. The user can add attendance constraints to the activities and the activity will take part in constraint and conflict resolution on an equal footing to all other activities in the user's calendar. The user can also update a subset of the information within the activity, in the same way that they can do for an invited activity. Any activities that are managed or in some way altered by the user will be communicated to the electronic calendar server 102 so that updates can be communicated to any other users affected by changes (for example if a constraint has been added by a particular user to an activity that directly affects one or more other users planning to attend the same activity).

The combination of the two features in the present invention mean that activities can be created and curated by the true owner of them (i.e. the football club in the above example), and users can subscribe to some or all of the activities as they see fit, without any of the traditional drawbacks.

### Location Aware

A further problem with traditional electronic calendars is that they are not location-aware. This causes many problems, but the most common one occurs when an activity occurs in a time zone other than that in which the user resides. In this situation it is incumbent on the user to carry out time zone translation for the activity so that the dates and times they put in for the activity match the time zone in which the user resides rather than that which the activity occurs. As most dates and times are supplied in the local time zone this is a constant cause of frustration and missed appointments, especially during times of transition such as the change to and from daylight savings time.

An embodiment of the present invention is location-aware, and takes information from the activity in to account when considering dates and times supplied in activities. When activities are created the local end-user device 106 or electronic calendar server 102 can use the location information supplied in the details for the activity to calculate the time zone in which the activity occurs and ensures that the dates and times are correct for that time zone.

### Concierge Request

Traditional electronic calendars are very much one-way, in that they act as a repository of activities that will be undertaken by a user. Embodiments of the present invention provides a totally new mechanism that allows users to create a request for an activity rather than an activity itself. In response to the request, the end-user device 106 can receive one or more suitable potential activities, either from local memory 204, and/or from the electronic calendar server 102.

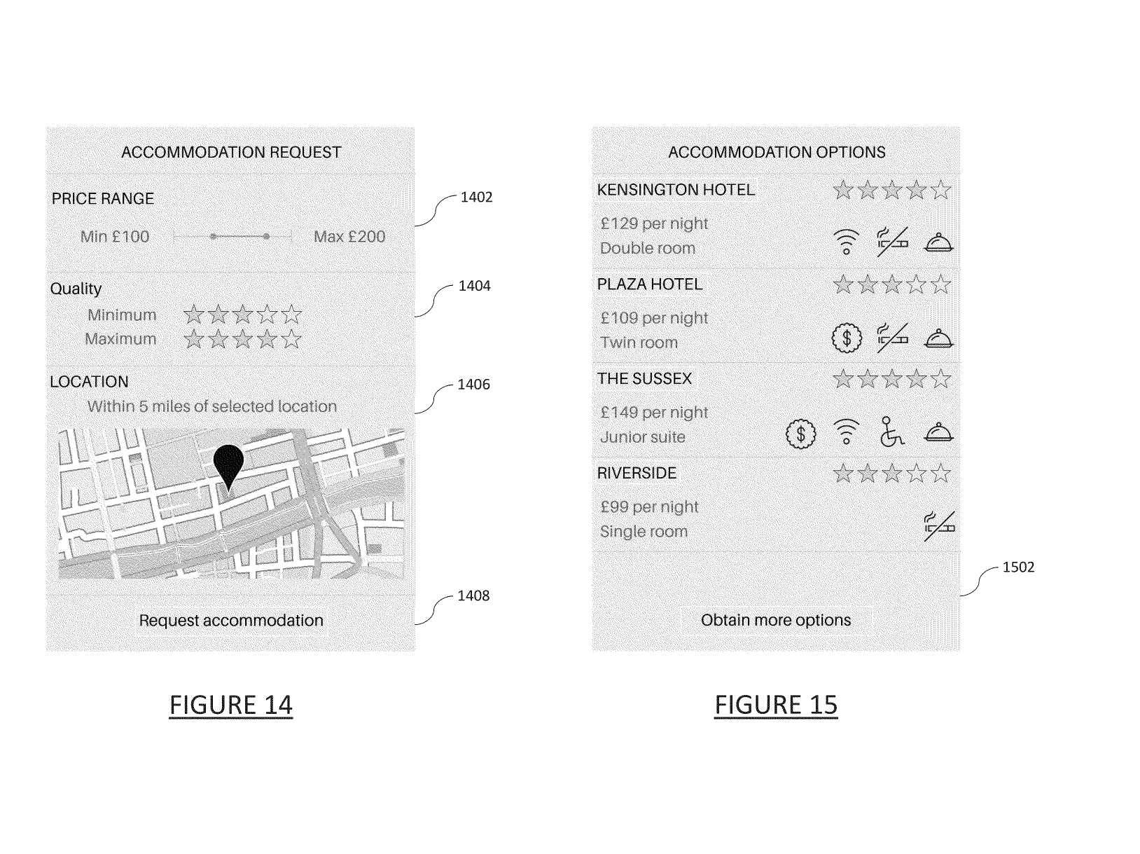

A user can use the electronic calendar application software 108 to create an activity request for a number of different types of activity such as, but not limited to: “accommodation”, “event” or “restaurant”. The user provides details such as time and place for the activity along with any criteria that might narrow down the suitable responses to be provided (as explained in detail below). For accommodation this might include, but is not limited to, number of stars, distance from a given point, and cost. For “event” this might include, but is not limited to, type of event (gig, theatre, exhibition), price of entry, and if it is ticketed or not. When a user uses the electronic calendar application software 108 to indicate that he intends to submit a request activity, the software 108 presents an interactive request window. An example of an interactive request window for “accommodation” is shown in FIG. 14. Here, the interactive request window includes a price range slider 1402 that the user can set, an accommodation quality range selector 1404, a location and distance setting 1406 which may utilise and access third-party mapping software (e.g. such as Google Maps), and a request button control 1408 which causes the electronic calendar application software 108 to provide the request to the electronic calendar server 102 which can store the data message in database 116. Further, the request may be stored in local memory 204 of the end-user device 106.

Once the user has created a request for an activity, the electronic calendar server 102 and/or electronic calendar application software at end-user device 106 uses the information provided by the user as the basis for obtaining potential activities which meet the user's requirements. However, the present invention does not rely purely on the information provided by the user and augments it with additional information from both the user's previous activities of a similar kind as well as other information from the activities currently in the user's calendar. Such additional information may be retrieved by the electronic calendar server 102 from the database 116. Alternatively or in addition, some of this additional information can also be retrieved directly from memory 204 at the end-user device 106 (for example if the end-user device is unable to connect to electronic calendar server 102). The complete request (augmented request) may be formed by either the electronic calendar server 102 or the electronic calendar application software 108. The complete request is then used to obtain potential activities which meet the user's requirements as described below.

The electronic calendar server 102 will use the complete request (augmented request) to send data relating to the complete request to one or more external data service 114. For example in this scenario the external data services would usually be an online booking systems running on one or more third party servers. In response, the external data service 114 returns results back to the electronic calendar server 102, where the results comprise one or more potential activities that match and/or closely match the requirements of the data relating to the complete request. The electronic calendar server 102 stores the results and attaches them to the complete request enabling the user retrieve the results and start a selection process at the local end-user device 106 where the user can select one or more of the potential activities.

In one example, if there is a meeting activity occurring in a user's calendar on the day for which a request activity is submitted, then the present invention will give preference to potential activities which are closer to the location of the meeting activity. Also, if the user has in the past requested four and five star hotels but has always ended up booking four star hotels based on the obtained potential activities provided to him, then four star hotels will be requested in preference to five star hotels.

If the end-user device 106 is unable to connect with the electronic calendar server 102, then the augmented request as stored at local memory 204 can be used to obtain some potential activities from its local memory 204. It will be appreciated that the selection of activities may be limited because the end-user device not being able to access live, up-to date information for potential activities via the electronic calendar server 102 and the external data services 114. However, the present invention can suggest some suitable potential activities to the user that are within a suitable time and distance of the requested time and location by drawing upon past activities stored in the local memory 204. The user can then start the selection process where the user can select one or more of the potential activities.

The user can either select one of the options provided or refine their criteria to obtain another set of responses. When a user selects a response, then any activity needed to confirm the response takes place, for example paying for accommodation or a ticket for an event, and the request activity becomes a normal activity.

FIG. 15 shows an example of a list of potential activities as presented at display 208 of the end-user device 106. The five potential results shown include live information obtained from the external data service 114. The user can select the “obtain more options” control button 1502 to retrieve more potential results or to refine their request to try and see more suitable or alternative potential activities.

Taking the above a step further, the present invention can also understand when a user is away from their home, due to the information provided about locations in activities, and provide suggestions as above without the user having to manually enter the request. This allows the electronic calendar server 102 to act as a concierge, understanding the user's requirements and able to provide suitable suggestions as to accommodation, meals and entertainment.

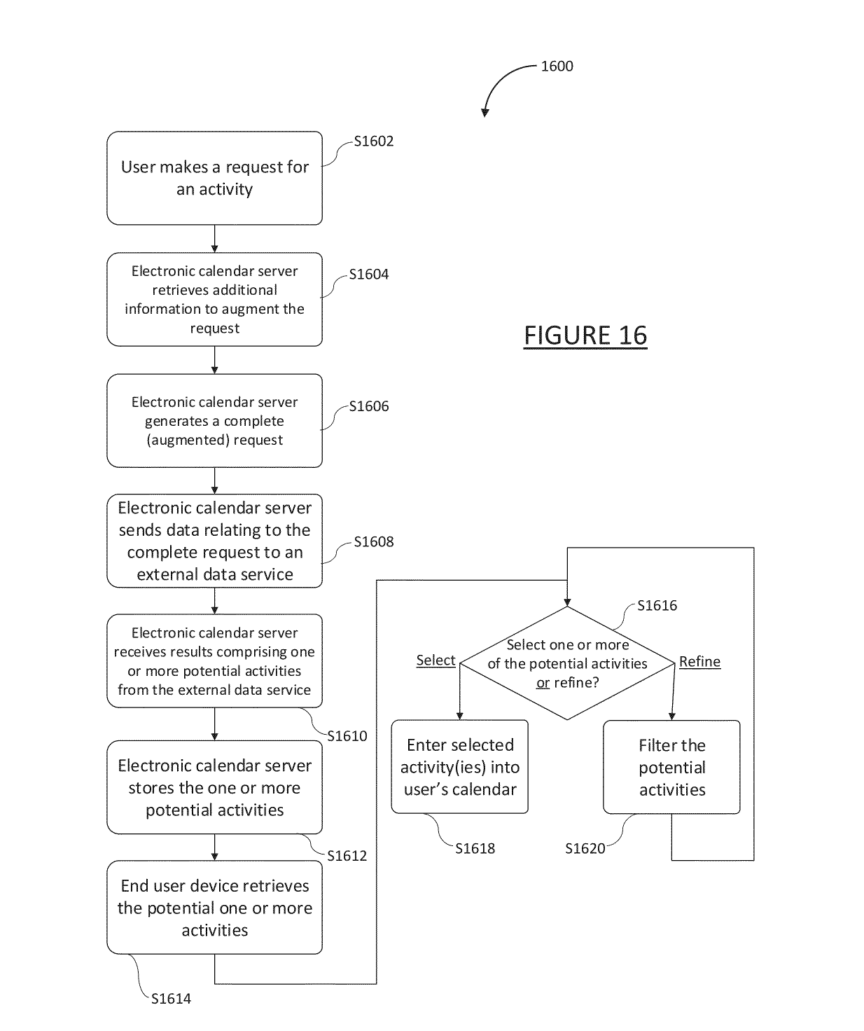

FIG. 16 shows a process flow 1600 which summarises the steps for making a request for an activity from an end-user device 106 and receiving potential activities in response. The process 1600 relates to the embodiment implementing the external data service 114 (e.g. online booking service).

At step S1602 a user of an end-user device 106 makes a request for an activity. At step S1604 the electronic calendar server 102 uses the time and location information provided in the request to retrieve additional information to augment the request. At step S1606, the electronic calendar server 102 generates a complete (augmented) request.

At step S1608 the electronic calendar server 102 sends data relating to the complete request to an external data service 114 (e.g. online booking service).

At step S1610 the electronic calendar server 102 receives results comprising one or more potential activities back from the external data service 114.

At step S1612 the electronic calendar server 102 stores the one or more potential activities from the external data service 114 and attaches them to the current request associated with the user.

At step S1614 the one or more potential activities are retrieved by the end-user device 106 for the user. The end-user device 106 may store the results in local memory 204 of the end-user device 106.

At step S1616 the user can either select one or more of the provided potential activities or select to refine the results. If the user chooses to select an activity (or activities), the activity is entered into his electronic calendar at step S1618, where the activity details are maintained by the electronic calendar server 102 (and electronic calendar database 116) and optionally by the electronic calendar application software 108.

If at step S1616 the user selects to refine the retrieved potential activities, the user can use the electronic calendar application software 108 to filter the results to find the potential activities he finds most desirable at step S1620. The user may continue to refine the potential activities until he can select one or more potential activities that he thinks is suitable. Otherwise, the user can ignore the obtained potential activities and submit an amended or new request for an activity back at step S1602.

### User Interface Examples

Due to the nature of the innovations described above, the resulting new ways of working the interface between the user and the invention required a number of novel features to be developed.

Traditional electronic calendars do not work in the same way that their users do. If asked, a user might describe an activity as “Lunch with Bob next Tuesday midday until 2 pm” but this bears little to no relationship to the way in which users interact with traditional electronic calendars. Instead, the user is presented with a number of options that attempt to ascertain a suitable name for the activity, the start and end time, location and, if very advanced, the participants. This process is not only error-prone but commonly too time-consuming for most users, resulting in activities not containing complete information.

The present invention allows a user to describe the activity in plain English, as shown above, using either written (e.g. typed) or spoken input via the end-user device microphone 216, to provide the information for the activity. If the present invention finds a situation which means it cannot fully resolve the activity details, for example if there are two people called “Bob” known to the user and stored in their contacts, it will ask for clarification and give an appropriate set of choices which allow the user to clarify the details and complete creation of the activity.

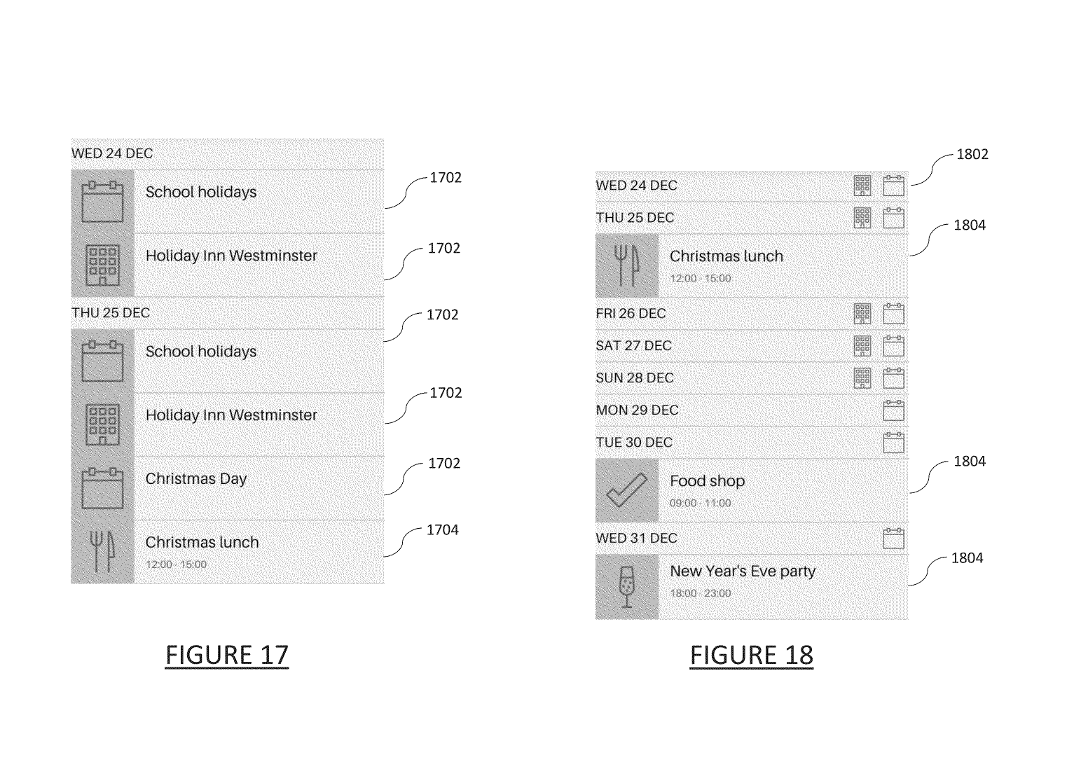

Another common problem with traditional electronic calendars is that the more activities that are added to a user's calendar, the less useful the calendar becomes. This is due to the simplistic display system where each activity has an equal weighting and so there is no way to preferentially display one activity over another, and results in too much space taken up on the user interface with unnecessary details as shown in FIG. 17. Here it can be seen that most of the information displayed in the user interface is of little value. A user will be aware of the holiday information 1702, and although important when arranging activities it is not useful for it to take up so much space as part of their agenda. The end result is that of the entire screen only a single activity 1704 is an actual event, and it is hard to locate.

The electronic calendar application software 108 considers each activity and weights it according to a number of factors, including the type of the activity, if it is happening or not, if the user has responded to it or not, if the user is attending it or not, user preferences regarding different types of activity, the timeframe of the activity relative to the time and date being displayed, and if the activity requires a response from the user. This results in a much improved user interface displayed on the screen 208 as it contains much more useful information as shown in FIG. 18.

FIG. 18 shows an example of the user interface in which lesser important activities are still displayed but as smaller icons 1802 next to each day in which they are relevant. This allows the more important activities to be easily visible, and also increases the number of important activities 1804 which are available on the limited screen space which is a feature of mobile devices.

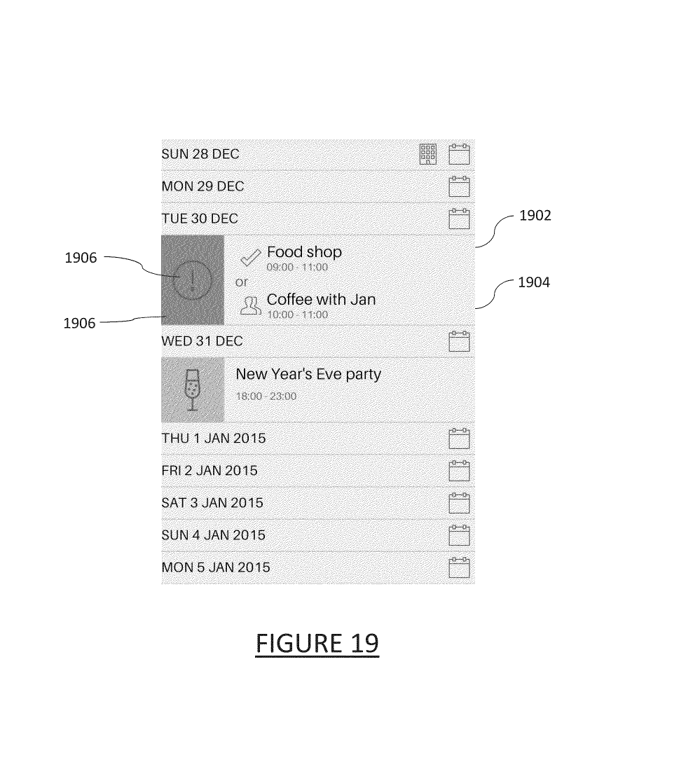

As described previously, the present invention understands schedule conflicts and attempts to resolve them automatically (see Conflict Resolution above). If this is not possible then the user needs to resolve the activities manually. An important part of the present invention is to show this information clearly and in a form which makes it obvious that action needs to be undertaken. An example of a clash or overlap of activities as seen in user interface on display 208, and which needs manual intervention is shown in FIG. 19. FIG. 19 specifically shows the user interface of an electronic calendar as displayed to the user. It can be seen that there are two overlapping activities: ‘Food shop’ 1902 and ‘Coffee with Jan’ 1904. The clash is highlighted with multiple visual cues 1906 and selecting the clash provides details of both activities and gives the user a chance to select one over the other, or to rearrange one of the activities so that the clash no longer takes place.

Although the above examples have been described as a series of different embodiments, it should be understood by the person skilled in the art that a number of these examples may be combined with one another. Other applications and configurations may be apparent to the person skilled in the art given the disclosure herein. The scope of the invention is not limited by the described embodiments, but only by the following claims.

1. A computer system for controlling a user interface, the system comprising:
a processor executing a calendar application as a computer program;
electronic storage connected to the processor for holding user data, activity data, and activity status;
a user input component configured to receive from a first user activity data defining an activity to be scheduled in a calendar, and a constraint associated with the activity;
a constraint input configured to receive constraint data;
wherein the calendar application is configured to process the constraint data to determine if the constraint has been met, and to set the activity status based on whether the constraint has been met and to generate control instructions for controlling a user interface to selectively present the activity to a user based on the activity status.

2. A computer system according to claim 1, wherein the user input component is configured to receive a constraint in the form of an occurrence constraint which defines at least one factor which governs whether or not the activity will take place.

3. A computer system according to claim 2, wherein the user input component is configured to receive as an occurrence constraint an identifier of at least one attendee for the activity, and where the calendar application is configured to generate an invitation in the form of an electronic message for despatch to the attendee.

4. A computer system according to claim 3, wherein the constraint input is configured to receive constraint data in the form of a response from the invited attendee, wherein the nature of the response defines whether or not the constraint has been met.

5. A computer system according to claim 1, wherein the constraint input is configured to monitor constraint data over time whereby the status of the activity changes with respect to time, resulting in a change to the selected presentation of the activity to a user on the user interface.

6. A computer system according to claim 5, wherein the constraint input is configured to receive a notification from the invited attendee wherein the response of the attendee has changed.

7. A computer system according to claim 1, wherein the user input component is configured to receive removal of a constraint from the first user.

8. A computer system according to claim 1, wherein the user input component is configured to receive a constraint defining alternatives, either one of which can be met to satisfy the constraint, wherein the constraint input is configured to monitor constraint data so that the calendar application recognises when either alternative has been met.

10. A computer system according to claim 2, wherein the user input component is configured to receive an occurrence constraint in the form of a prioritized list of attendees, and where the calendar application is configured to generate an invitation for the first attendee in the prioritized list and to monitor a response received from the first invited attendee, wherein if the response is positive, no invitation is sent to a second attendee on the list, and wherein if the response is negative is negative, the calendar application is configured to generate a further invitation to a second attendee on the list and to monitor the response from the second attendee.

11. A computer system according to claim 2, wherein the user input is configured to receive a constraint in the form of a prevailing weather condition which must occur for the activity to take place, and where the constraint input is configured to receive constraint data from a source of weather data.

12. A computer system according to claim 2, wherein the user input component is configured to receive an occurrence constraint only from the first user.

13. A computer system according to claim 1, wherein the user input component is configured to receive a constraint from at least one other user of the system, wherein each of the first user and the one other user are associated with respective user identifiers forming part of the their user data.

14. A computer system according to claim 13, wherein the user input component is configured to receive from the at least one other user an attendance constraint which defines that at least one further user is required to attend the activity to satisfy the constraint.

15. A computer system according to claim 14, wherein the calendar application is configured to generate control instructions for a user interface associated with the other user and to selectively present the activity to the other user based on the activity status associated with the other user, which is based on whether or not the attendance constraint has been met.

16. A computer system according to claim 1, wherein the calendar application is configured to generate first control instructions for a first user and second control instructions for a second user, the first and second control instructions pertaining to the same activity but controlling a user interface associated with a first and second user respectively in different ways based on a first activity status for the first user and a second activity status for the second user.

17. A computer system according to claim 1, wherein the constraint input is configured to receive constraint data from a source external to the computer system.

18. A computer system according to claim 1, wherein the constraint input is configured to receive constraint data from a source internal to the computer system.

19. A computer system for controlling a user interface comprising:
a processor executing a calendar application as computer program;
electronic storage connected to the processor for holding user data, activity data, and permission data;
a user input component configured to receive from a user activity data defining an activity to be scheduled in a calendar, and privacy data associated with the activity, wherein the privacy data defines viewing permissions for the activities;
wherein the calendar application is configured to receive a request from a user to view a calendar and to present to the user interface only activities associated with privacy data which grant the requesting user permission to view the activity.

20. A computer system for controlling a user interface, the system comprising:
a processor executing a calendar application as a computer program;
electronic storage connected to the processor for holding user data and activity data;
an input component configured to receive activity data defining multiple activities to be scheduled in a calendar for a user;
a conflict resolution module configured to select one of said multiple activities requesting to be scheduled in a common timeslot, and operate to selectively present only one of the multiple activities to the user in the timeslot.
